(19) United States
(12) Patent Application Publication
(10) Pub. No.: US 2017/0193119 A1
(43) Pub. Date: Jul. 6, 2017

(54) Add-On Module Search System

(71) Applicant: Quixey, Inc., Mountain View, CA (US)

(72) Inventors: Sharad UNNI, Lathrop, CA (US); Eric GLOVER, Palo Alto, CA (US); Jacob ORRIN, Sunnyvale, CA (US); Joseph BARRIENTOS, Sunnyvale, CA (US); Hadar DOR, Sunnyvale, CA (US); Chandana SRINIVASA, Los Angeles, CA (US); Xueying DAI, Santa Clara, CA (US)

(21) Appl. No.: 15/396,586

(22) Filed: Dec. 31, 2016

Related U.S. Application Data
(60) Provisional application No. 62/273,567, filed on Dec. 31, 2015.

(51) Int. Cl. G06F 17/30; H04L 29/08

(52) U.S. Cl. CPC G06F 17/30867; H04L 67/02; G06F 17/30696

(57) ABSTRACT

A method includes receiving, by one or more processors of a user device, a uniform resource locator (URL) and obtaining a webpage at the URL. The method includes displaying the obtained webpage on a display of the user device, determining a webpage keyword from the obtained webpage, and transmitting the webpage keyword to a search system. The method includes receiving keyword card results from the search system selected based on the webpage keyword. Each keyword card result of the keyword card results includes, for a respective user-selectable link, a respective access mechanism. The method includes, concurrently with the displaying of the obtained webpage, displaying on the display of the user device, the user-selectable links for the keyword card results, respectively. The method includes, in response to user selection of one of the user-selectable links, executing the respective access mechanism of the respective keyword card result.

### CROSS-REFERENCE TO RELATED APPLICATIONS

This application claims the benefit of U.S. Provisional Application No. 62/273,567, filed on Dec. 31, 2015. The entire disclosure of the application referenced above is incorporated by reference.

### FIELD

This disclosure relates to add-on module search systems.

### BACKGROUND

In recent years, use of computers, smartphones, and other Internet-connected devices has grown exponentially. Correspondingly, the number of available software applications for such devices has also grown. Today, many diverse native and web software applications can be accessed on any number of different devices, including, but not limited to, smartphones, personal computers, automobiles, and televisions. These diverse applications can range from business driven applications, games, educational applications, news applications, shopping applications, messaging applications, media streaming applications, social networking applications, and so much more. Users continually search and browse the internet through web browsers. Web browsers may be integrated with add-on systems to provide additional functions. While some add-ons provide browsing functionality, current add-ons fail to deliver additional related content to normal content being delivered to the user's web browser during a normal browsing experience.

### SUMMARY

In a feature, a method includes: receiving, by one or more processors of a user device, a uniform resource locator (URL); obtaining, by the one or more processors, a webpage at the URL; displaying, by the one or more processors, the obtained webpage on a display of the user device; determining, by the one or more processors, a webpage keyword from the obtained webpage; transmitting, by the one or more processors, the webpage keyword to a search system; receiving, by the one or more processors, keyword card results from the search system selected based on the webpage keyword, where each keyword card result of the keyword card results includes, for a respective user-selectable link, a respective access mechanism: that is associated with an application that is executable by the one or more processors; and that, when executed by the one or more processors, causes the one or more processors to transition the application to a specific state that provides content related to the webpage keyword. The method further includes: concurrently with the displaying of the obtained webpage, displaying on the display of the user device, by the one or more processors, the user-selectable links for the keyword card results, respectively; and in response to user selection of one of the user-selectable links executing, by the one or more processors, the respective access mechanism of the respective keyword card result.

In further features, determining the webpage keyword includes, by the one or more processors, determining the webpage keyword from a title of a document object model (DOM) of the obtained webpage.

In further features, determining the webpage keyword includes: by the one or more processors, executing a Rapid Automatic Keyword Extraction (RAKE) algorithm on text of the obtained webpage to determine candidate keywords; and selecting one of the candidate keywords as the webpage keyword.

In further features, determining the webpage keyword includes: determining candidate keywords from the obtained webpage; determining word scores for the candidate keywords, respectively; for each candidate keyword of the candidate keywords, selectively adjusting the word score of the candidate keyword based on at least one of: one or more locations of the candidate keyword within the obtained webpage; one or more typefaces of the candidate keyword within the obtained webpage; one or more font sizes of the candidate keyword within the obtained webpage; and a usage frequency of the candidate keyword within the obtained webpage; and selecting as the webpage keyword, by the one or more processors, the one of the candidate keywords with a highest one of the word scores.

In further features, determining the webpage keyword includes: determining candidate keywords from the obtained webpage; ranking the candidate keywords based on frequencies of appearance of the candidate keywords, respectively, in the obtained webpage; and selecting as the webpage keyword, by the one or more processors, the one of the candidate keywords with a highest ranking.

In further features, the method further includes: receiving, by the one or more processors, a trending card result from the search system selected based on a trending keyword, where the trending card result includes, for a second user-selectable link, a second access mechanism: that is associated with an application that is executable by the one or more processors of the user device; and that, when executed by the one or more processors, causes the one or more processors to transition the application to a specific state that provides content related to the trending keyword; displaying on the display of the user device, by the one or more processors, the second user-selectable link for the trending card result; and in response to user selection of the second user-selectable link executing, by the one or more processors, the second access mechanism of the trending card result.

In further features, the method further includes by the one or more processors, replacing on the display, one of the user-selectable links for the keyword card results with the second user-selectable link for the trending card result.

In further features: each keyword card result of the keyword card results further includes data associated with an image and data associated with text; and the method further includes displaying on the display, by the one or more processors, the images and the text of the keyword card results with the user-selectable links, respectively.

In further features, the displaying the user-selectable links includes displaying the user-selectable links only in response to receipt of predetermined user input, by the one or more processors, to display the user-selectable links.

In a feature, a method includes: receiving, by one or more processors of a user device, a uniform resource locator (URL); obtaining, by the one or more processors, a webpage at the URL; displaying, by the one or more processors, the obtained webpage on a display of the user device; transmitting, by the one or more processors, the URL for the obtained webpage to a search system; receiving, by the one or more processors, keyword card results from the search system selected by the search system based on a webpage keyword for the obtained webpage, where each keyword card result of the keyword card results includes, for a respective user-selectable link, a respective access mechanism: that is associated with an application that is executable by the one or more processors; and that, when executed by the one or more processors, causes the one or more processors to transition the application to a specific state that provides content related to the URL. The method further includes: concurrently with displaying the obtained webpage, displaying on the display of the user device, by the one or more processors, the user-selectable links for the keyword card results, respectively; and in response to user selection of the user-selectable links executing, by the one or more processors, the respective access mechanisms of the respective keyword card results.

In further features, the method further includes: receiving, by the one or more processors, a trending card result from the search system selected based on a trending keyword, where the trending card result includes, for a second user-selectable link, a second access mechanism: that is associated with an application that is executable by the one or more processors; and that, when executed by the one or more processors, causes the one or more processors to transition the application to a specific state that provides content related to the trending keyword; displaying on the display of the user device, by the one or more processors, the second user-selectable link for the trending card result; and in response to user selection of the second user-selectable link executing, by the one or more processors, the second access mechanism of the trending card result.

In further features, the method further includes, by the one or more processors, replacing on the display, one of the user-selectable links for the keyword card results with the second user-selectable link for the trending card result.

In further features: each keyword card result of the keyword card results further includes data associated with an image and data associated with text, and the method further includes displaying on the display, by the one or more processors, the images and the text of the keyword card results with the user-selectable links, respectively.

In further features, the displaying on the display, the user-selectable links for the keyword card results, respectively, includes displaying the user-selectable links only in response to receipt of predetermined user input, by the one or more processors, to display the user-selectable links.

In a feature, a method includes: receiving, by one or more processors of a search system from a user device, a uniform resource locator (URL) of a webpage navigated to by the user device; obtaining, by the one or more processors, the webpage at the URL; determining, by the one or more processors, a webpage keyword from the obtained webpage; based on the webpage keyword, by the one or more processors, selecting keyword card results from a plurality of keyword card results stored in a data store, where each keyword card result of the keyword card results includes, for a respective user-selectable link for display by the user device, a respective access mechanism: that is associated with an application that is executable by the user device; and that, when executed by the user device, causes the user device to transition the application to a specific state that provides content related to the webpage keyword; and by the one or more processors, transmitting the keyword card results to the user device, where, in response to user selection of the user-selectable links, the user device executes the respective access mechanisms of the respective keyword card results.

In further features, determining the webpage keyword includes, by the one or more processors, determining the webpage keyword from a title of a document object model (DOM) of the obtained webpage.

In further features, determining the webpage keyword from the obtained webpage includes: by the one or more processors, executing a Rapid Automatic Keyword Extraction (RAKE) algorithm on text of the obtained webpage to determine candidate keywords for the obtained webpage; and by the one or more processors, selecting one of the candidate keywords as the webpage keyword.

In further features, determining the webpage keyword includes: determining candidate keywords from the obtained webpage; determining word scores for the candidate keywords, respectively; for each candidate keyword of the candidate keywords, selectively adjusting the word score of the candidate keyword based on at least one of: one or more locations of the candidate keyword within the obtained webpage; one or more typefaces of the candidate keyword within the obtained webpage; one or more font sizes of the candidate keyword within the obtained webpage; and a usage frequency of the candidate keyword within the obtained webpage; and selecting as the webpage keyword, by the one or more processors, the one of the candidate keywords with a highest one of the word scores.

In further features, determining the webpage keyword includes: determining candidate keywords from the obtained webpage; ranking the candidate keywords based on frequencies of appearance of the candidate keywords, respectively, in the obtained webpage; and selecting as the webpage keyword, the one of the candidate keywords with a highest ranking.

In further features, the method further includes: selecting, by the one or more processors, a trending card result based on a trending keyword, where the trending card result includes, for a second-user selectable link, a second access mechanism: that is associated with an application that is executable by the user device; and that, when executed by the user device, causes the user device to transition the application to a specific state that provides content related to the trending keyword; and by the one or more processors, transmitting the trending card result to the user device with the keyword card results, where, in response to user selection of the second user-selectable link, the user device executes the second access mechanism of the trending card result.

In further features, the method further includes, by the one or more processors, replacing one of the keyword card results with the trending card result.

In a feature, a method includes: receiving from a user device, by one or more processors of a search system, a webpage keyword for a webpage navigated to by the user device; based on the webpage keyword, by the one or more processors, selecting keyword card results from a plurality of keyword card results stored in a data store, where each keyword card result of the keyword card results includes, for a respective user-selectable link for display by the user device, a respective access mechanism: that is associated with an application that is executable by the one or more processors of the user device; and that, when executed by the user device, causes the user device to transition the application to a specific state that provides content related to the webpage keyword; and, by the one or more processors, transmitting the keyword card results to the user device, where, in response to user selection of the user-selectable links, the user device executes the respective access mechanisms of the respective keyword card results.

In further features, the method further includes: selecting, by the one or more processors, a trending card result based on a trending keyword, where the trending card result includes, for a second user-selectable link, a second access mechanism: that is associated with an application that is executable by the user device; and that, when executed by the user device, causes the user device to transition the application to a specific state that provides content related to the trending keyword; and by the one or more processors, transmitting the trending card result to the user device with the keyword card results, where, in response to user selection of the second user-selectable link, the user device executes the second access mechanism of the trending card result.

In further features, the method further includes, by the one or more processors, replacing one of the keyword card results with the trending card result.

In a feature, a method includes: receiving, by one or more processors of a user device, a search string to be searched for by a search engine; obtaining from a search engine, by the one or more processors, a search engine results page (SERP) for the search string; displaying, by the one or more processors, the SERP on a display of the user device; transmitting, by the one or more processors, the search string to a search system that is separate from the search engine; receiving, by the one or more processors, keyword card results from the search system selected based on the search string, where each keyword card result of the keyword card results includes, for a respective user-selectable link, a respective access mechanism: that is associated with an application that is executable by the one or more processors; and that, when executed by the one or more processors, cause the one or more processors to transition the application to a specific state that provides content related to the search string; concurrently with displaying the SERP, displaying on the display of the user device, by the one or more processors, the user-selectable links for the keyword card results, respectively; and in response to user selection of the user-selectable links executing, by the one or more processors, the respective access mechanisms of the respective keyword card results.

In further features, the method further includes, by the one or more processors, obtaining the search string from a portion of a URL of the SERP.

In further features, the method further includes, by the one or more processors, obtaining the search string from a search field of a webpage of the search engine.

In further features, the method further includes, by the one or more processors, obtaining the search string from a search field of an application being executed by the one or more processors.

In further features, the method further includes: receiving, by the one or more processors, a trending card result from the search system selected based on a trending keyword, where the trending card result includes, for a second user-selectable link, a second access mechanism: that is associated with an application that is executable by the one or more processors of the user device; and that, when executed by the one or more processors, causes the one or more processors to transition the application to a specific state that provides content related to the trending keyword; displaying on the display of the user device, by the one or more processors, the second user-selectable link for the trending card result; and in response to user selection of the second user-selectable link executing, by the one or more processors, the second access mechanism of the trending card result.

In further features, the method further includes, by the one or more processors, replacing on the display one of the user-selectable links for the keyword card results with the second user-selectable link for the trending card result.

In further features: each keyword card result of the keyword card results further includes data associated with an image and data associated with text; and the method further includes displaying on the display, by the one or more processors, the images and the text of the keyword card results with the user-selectable links, respectively.

In further features, the displaying on the display, the user-selectable links for the keyword card results, respectively, includes displaying the user-selectable links only in response to receipt of predetermined user input, by the one or more processors, to display the user-selectable links.

In a feature, a user device includes: a display; one or more processors; and memory including code that, when executed by the one or more processors, causes the one or more processors to perform functions including: receiving a uniform resource locator (URL); obtaining a webpage at the URL; displaying the obtained webpage on the display; determining a webpage keyword from the obtained webpage; transmitting the webpage keyword to a search system; receiving keyword card results from the search system selected based on the webpage keyword, where each keyword card result of the keyword card results includes, for a respective user-selectable link, a respective access mechanism: that is associated with an application that is executable by the one or more processors; and that, when executed by the one or more processors, causes the one or more processors to transition the application to a specific state that provides content related to the webpage keyword; concurrently with the displaying of the obtained webpage, displaying on the display of the user device, the user-selectable links for the keyword card results, respectively; and in response to user selection of one of the user-selectable links, executing the respective access mechanism of the respective keyword card result.

In further features, the code for determining the webpage keyword includes code for determining the webpage keyword from a title of a document object model (DOM) of the obtained webpage.

In further features, the code for determining the webpage keyword includes code for: executing a Rapid Automatic Keyword Extraction (RAKE) algorithm on text of the obtained webpage to determine candidate keywords; and selecting one of the candidate keywords as the webpage keyword.

In further features, the code for determining the webpage keyword includes code for: determining candidate keywords from the obtained webpage; determining word scores for the candidate keywords, respectively; for each candidate keyword of the candidate keywords, selectively adjusting the word score of the candidate keyword based on at least one of: one or more locations of the candidate keyword within the obtained webpage; one or more typefaces of the candidate keyword within the obtained webpage; one or more font sizes of the candidate keyword within the obtained webpage; and a usage frequency of the candidate keyword within the obtained webpage; and selecting, as the webpage keyword, the one of the candidate keywords with a highest one of the word scores.

In further features, the code for determining the webpage keyword includes code for: determining candidate keywords from the obtained webpage; ranking the candidate keywords based on frequencies of appearance of the candidate keywords, respectively, in the obtained webpage; and selecting, as the webpage keyword, the one of the candidate keywords with a highest ranking.

In further features, the code further includes code for: receiving a trending card result from the search system selected based on a trending keyword, where the trending card result includes, for a second user-selectable link, a second access mechanism: that is associated with an application that is executable by the one or more processors; and that, when executed by the one or more processors, causes the one or more processors to transition the application to a specific state that provides content related to the trending keyword; displaying on the display the second user-selectable link for the trending card result; and in response to user selection of the second user-selectable link executing the second access mechanism of the trending card result.

In further features, the code further includes code for replacing on the display, one of the user-selectable links for the keyword card results with the second user-selectable link for the trending card result.

In further features, the code includes code for: each keyword card result of the keyword card results further includes data associated with an image and data associated with text; and the code further includes code for displaying on the display the images and the text of the keyword card results with the user-selectable links, respectively.

In further features, the code for displaying the user-selectable links includes code for displaying the user-selectable links only in response to receipt of predetermined user input to display the user-selectable links.

In a feature, a user device includes: a display; one or more processors; and memory including code that, when executed by the one or more processors, causes the one or more processors to perform functions including: receiving a uniform resource locator (URL); obtaining a webpage at the URL; displaying the obtained webpage on a display of the user device; transmitting the URL for the obtained webpage to a search system; receiving keyword card results from the search system selected by the search system based on a webpage keyword for the obtained webpage, where each keyword card result of the keyword card results includes, for a respective user-selectable link, a respective access mechanism: that is associated with an application that is executable by the one or more processors; and that, when executed by the one or more processors, causes the one or more processors to transition the application to a specific state that provides content related to the URL; concurrently with displaying the obtained webpage, displaying on the display of the user device the user-selectable links for the keyword card results, respectively; and in response to user selection of the user-selectable links, executing the respective access mechanisms of the respective keyword card results.

In further features, the code further includes code for: receiving a trending card result from the search system selected based on a trending keyword, where the trending card result includes, for a second user-selectable link, a second access mechanism: that is associated with an application that is executable by the one or more processors; and that, when executed by the one or more processors, causes the one or more processors to transition the application to a specific state that provides content related to the trending keyword; displaying on the display of the user device the second user-selectable link for the trending card result; and in response to user selection of the second user-selectable link, executing the second access mechanism of the trending card result.

In further features, the code further includes code for replacing on the display, one of the user-selectable links for the keyword card results with the second user-selectable link for the trending card result.

In further features, the code for each keyword card result of the keyword card results further include data associated with an image and data associated with text, and the code further include code for displaying on the display the images and the text of the keyword card results with the user-selectable links, respectively.

In further features, the code for displaying on the display, the user-selectable links for the keyword card results, respectively, includes code for displaying the user-selectable links only in response to receipt of predetermined user input to display the user-selectable links.

In a feature, a search system includes: one or more processors; and memory including code that, when executed by the one or more processors, causes the one or more processors to perform functions including: receiving, from a user device, a uniform resource locator (URL) of a webpage navigated to by the user device; obtaining the webpage at the URL; determining a webpage keyword from the obtained webpage; based on the webpage keyword, selecting keyword card results from a plurality of keyword card results stored in a data store, where each keyword card result of the keyword card results includes, for a respective user-selectable link for display by the user device, a respective access mechanism: that is associated with an application that is executable by the user device; and that, when executed by the user device, causes the user device to transition the application to a specific state that provides content related to the webpage keyword; and transmitting the keyword card results to the user device, where, in response to user selection of the user-selectable links, the user device executes the respective access mechanisms of the respective keyword card results.

In further features, the code for determining the webpage keyword includes code for determining the webpage keyword from a title of a document object model (DOM) of the obtained webpage.

In further features, the code for determining the webpage keyword from the obtained webpage include code for: executing a Rapid Automatic Keyword Extraction (RAKE) algorithm on text of the obtained webpage to determine candidate keywords for the obtained webpage; and selecting one of the candidate keywords as the webpage keyword.

In further features, the code for determining the webpage keyword include code for: determining candidate keywords from the obtained webpage; determining word scores for the candidate keywords, respectively; for each candidate keyword of the candidate keywords, selectively adjusting the word score of the candidate keyword based on at least one of: one or more locations of the candidate keyword within the obtained webpage; one or more typefaces of the candidate keyword within the obtained webpage; one or more font sizes of the candidate keyword within the obtained webpage; and a usage frequency of the candidate keyword within the obtained webpage; and selecting as the webpage keyword, the one of the candidate keywords with a highest one of the word scores.

In further features, the code for determining the webpage keyword include code for: determining candidate keywords from the obtained webpage; ranking the candidate keywords based on frequencies of appearance of the candidate keywords, respectively, in the obtained webpage; and selecting as the webpage keyword, the one of the candidate keywords with a highest ranking.

In further features, the code further include code for: selecting a trending card result based on a trending keyword, where the trending card result includes, for a second-user selectable link, a second access mechanism: that is associated with an application that is executable by the user device; and that, when executed by the user device, causes the user device to transition the application to a specific state that provides content related to the trending keyword; and transmitting the trending card result to the user device with the keyword card results, where, in response to user selection of the second user-selectable link, the user device executes the second access mechanism of the trending card result.

In further features, the code further includes code for replacing one of the keyword card results with the trending card result.

In a feature, a search system includes: one or more processors; and memory including code that, when executed by the one or more processors, causes the one or more processors to perform functions including: receiving, from a user device, a webpage keyword for a webpage navigated to by the user device; based on the webpage keyword, selecting keyword card results from a plurality of keyword card results stored in a data store, where each keyword card result of the keyword card results includes, for a respective user-selectable link for display by the user device, a respective access mechanism: that is associated with an application that is executable by the one or more processors of the user device; and that, when executed by the user device, causes the user device to transition the application to a specific state that provides content related to the webpage keyword; and, transmitting the keyword card results to the user device, where, in response to user selection of the user-selectable links, the user device executes the respective access mechanisms of the respective keyword card results.

In further features, the code further include code for: selecting a trending card result based on a trending keyword, where the trending card result includes, for a second user-selectable link, a second access mechanism: that is associated with an application that is executable by the user device; and, when executed by the user device, causes the user device to transition the application to a specific state that provides content related to the trending keyword; and transmitting the trending card result to the user device with the keyword card results, where, in response to user selection of the second user-selectable link, the user device executes the second access mechanism of the trending card result.

In further features, the code further includes code for replacing one of the keyword card results with the trending card result.

In a feature, a user device includes: a display; one or more processors; and memory including code that, when executed by the one or more processors, causes the one or more processors to perform functions including: receiving a search string to be searched for by a search engine; obtaining from a search engine a search engine results page (SERP) for the search string; displaying the SERP on a display of the user device; transmitting the search string to a search system that is separate from the search engine; receiving keyword card results from the search system selected based on the search string, where each keyword card result of the keyword card results includes, for a respective user-selectable link, a respective access mechanism: that is associated with an application that is executable by the one or more processors; and that, when executed by the one or more processors, cause the one or more processors to transition the application to a specific state that provides content related to the search string; concurrently with displaying the SERP, displaying on the display of the user device, the user-selectable links for the keyword card results, respectively; and in response to user selection of the user-selectable links, executing the respective access mechanisms of the respective keyword card results.

In further features, the code further includes code for obtaining the search string from a portion of a URL of the SERP.

In further features, the code further includes code for obtaining the search string from a search field of a webpage of the search engine.

In further features, the code further includes code for obtaining the search string from a search field of an application being executed by the one or more processors.

In further features, the code further include code for: receiving a trending card result from the search system selected based on a trending keyword, where the trending card result includes, for a second user-selectable link, a second access mechanism: that is associated with an application that is executable by the one or more processors of the user device; and that, when executed by the one or more processors, causes the one or more processors to transition the application to a specific state that provides content related to the trending keyword; displaying on the display of the user device the second user-selectable link for the trending card result; and in response to user selection of the second user-selectable link executing the second access mechanism of the trending card result.

In further features, the code further include code for replacing on the display one of the user-selectable links for the keyword card results with the second user-selectable link for the trending card result.

In further features: the code for each keyword card result of the keyword card results further include data associated with an image and data associated with text; and the code further include code for displaying on the display the images and the text of the keyword card results with the user-selectable links, respectively.

In further features, the code for displaying on the display, the user-selectable links for the keyword card results, respectively, includes code for displaying the user-selectable links only in response to receipt of predetermined user input to display the user-selectable links.

In a feature, a non-transitory computer-readable medium stores instructions for execution by one or more processors of a user device, the instructions include instructions for: receiving a uniform resource locator (URL); obtaining a webpage at the URL; displaying the obtained webpage on the display; determining a webpage keyword from the obtained webpage; transmitting the webpage keyword to a search system; receiving keyword card results from the search system selected based on the webpage keyword, where each keyword card result of the keyword card results includes, for a respective user-selectable link, a respective access mechanism: that is associated with an application that is executable by the one or more processors; and that, when executed by the one or more processors, causes the one or more processors to transition the application to a specific state that provides content related to the webpage keyword; concurrently with the displaying of the obtained webpage, displaying on the display of the user device, the user-selectable links for the keyword card results, respectively; and in response to user selection of one of the user-selectable links, executing the respective access mechanism of the respective keyword card result.

In further features, the instructions for determining the webpage keyword include instructions for determining the webpage keyword from a title of a document object model (DOM) of the obtained webpage.

In further features, the instructions for determining the webpage keyword include instructions for: executing a Rapid Automatic Keyword Extraction (RAKE) algorithm on text of the obtained webpage to determine candidate keywords; and selecting one of the candidate keywords as the webpage keyword.

In further features, the instructions for determining the webpage keyword include instructions for: determining candidate keywords from the obtained webpage; determining word scores for the candidate keywords, respectively; for each candidate keyword of the candidate keywords, selectively adjusting the word score of the candidate keyword based on at least one of: one or more locations of the candidate keyword within the obtained webpage; one or more typefaces of the candidate keyword within the obtained webpage; one or more font sizes of the candidate keyword within the obtained webpage; and a usage frequency of the candidate keyword within the obtained webpage; and selecting, as the webpage keyword, the one of the candidate keywords with a highest one of the word scores.

In further features, the instructions for determining the webpage keyword include instructions for: determining candidate keywords from the obtained webpage; ranking the candidate keywords based on frequencies of appearance of the candidate keywords, respectively, in the obtained webpage; and selecting, as the webpage keyword, the one of the candidate keywords with a highest ranking.

In further features, the instructions further include instructions for: receiving a trending card result from the search system selected based on a trending keyword, where the trending card result includes, for a second user-selectable link, a second access mechanism: that is associated with an application that is executable by the one or more processors; and that, when executed by the one or more processors, causes the one or more processors to transition the application to a specific state that provides content related to the trending keyword; displaying on the display the second user-selectable link for the trending card result; and in response to user selection of the second user-selectable link executing the second access mechanism of the trending card result.

In further features, the instructions further include instructions for replacing on the display, one of the user-selectable links for the keyword card results with the second user-selectable link for the trending card result.

In further features: each keyword card result of the keyword card results further include data associated with an image and data associated with text; and the instructions further include instructions for displaying on the display the images and the text of the keyword card results with the user-selectable links, respectively.

In further features, the instructions for displaying the user-selectable links include instructions for displaying the user-selectable links only in response to receipt of predetermined user input to display the user-selectable links.

In a feature, a non-transitory computer-readable medium stores instructions for execution by one or more processors of a user device, the instructions include instructions for: receiving a uniform resource locator (URL); obtaining a webpage at the URL; displaying the obtained webpage on a display of the user device; transmitting the URL for the obtained webpage to a search system; receiving keyword card results from the search system selected by the search system based on a webpage keyword for the obtained webpage, where each keyword card result of the keyword card results includes, for a respective user-selectable link, a respective access mechanism: that is associated with an application that is executable by the one or more processors; and that, when executed by the one or more processors, causes the one or more processors to transition the application to a specific state that provides content related to the URL; concurrently with displaying the obtained webpage, displaying on the display of the user device the user-selectable links for the keyword card results, respectively; and in response to user selection of the user-selectable links, executing the respective access mechanisms of the respective keyword card results.

In further features, the instructions further include instructions for: receiving a trending card result from the search system selected based on a trending keyword, where the trending card result includes, for a second user-selectable link, a second access mechanism: that is associated with an application that is executable by the one or more processors; and that, when executed by the one or more processors, causes the one or more processors to transition the application to a specific state that provides content related to the trending keyword; displaying on the display of the user device the second user-selectable link for the trending card result; and in response to user selection of the second user-selectable link, executing the second access mechanism of the trending card result.

In further features, the instructions further include instructions for replacing on the display, one of the user-selectable links for the keyword card results with the second user-selectable link for the trending card result.

In further features, the instructions each keyword card result of the keyword card results include data associated with an image and data associated with text, and the instructions further include instructions for displaying on the display the images and the text of the keyword card results with the user-selectable links, respectively.

In further features, the instructions for displaying on the display, the user-selectable links for the keyword card results, respectively, include instructions for displaying the user-selectable links only in response to receipt of predetermined user input to display the user-selectable links.

In a feature, a non-transitory computer-readable medium stores instructions for execution by one or more processors of a search system, the instructions including instructions for: receiving, from a user device, a uniform resource locator (URL) of a webpage navigated to by the user device; obtaining the webpage at the URL; determining a webpage keyword from the obtained webpage; based on the webpage keyword, selecting keyword card results from a plurality of keyword card results stored in a data store, where each keyword card result of the keyword card results includes, for a respective user-selectable link for display by the user device, a respective access mechanism: that is associated with an application that is executable by the user device; and that, when executed by the user device, causes the user device to transition the application to a specific state that provides content related to the webpage keyword; and transmitting the keyword card results to the user device, where, in response to user selection of the user-selectable links, the user device executes the respective access mechanisms of the respective keyword card results.

In further features, the instructions for determining the webpage keyword include instructions for determining the webpage keyword from a title of a document object model (DOM) of the obtained webpage.

In further features, the instructions for determining the webpage keyword from the obtained webpage include instructions for: executing a Rapid Automatic Keyword Extraction (RAKE) algorithm on text of the obtained webpage to determine candidate keywords for the obtained webpage; and selecting one of the candidate keywords as the webpage keyword.

In further features, the instructions for determining the webpage keyword include instructions for: determining candidate keywords from the obtained webpage; determining word scores for the candidate keywords, respectively; for each candidate keyword of the candidate keywords, selectively adjusting the word score of the candidate keyword based on at least one of: one or more locations of the candidate keyword within the obtained webpage; one or more typefaces of the candidate keyword within the obtained webpage; one or more font sizes of the candidate keyword within the obtained webpage; and a usage frequency of the candidate keyword within the obtained webpage; and selecting as the webpage keyword, the one of the candidate keywords with a highest one of the word scores.

In further features, the instructions for determining the webpage keyword include instructions for: determining candidate keywords from the obtained webpage; ranking the candidate keywords based on frequencies of appearance of the candidate keywords, respectively, in the obtained webpage; and selecting as the webpage keyword, the one of the candidate keywords with a highest ranking.

In further features, the instructions further include instructions for: selecting a trending card result based on a trending keyword, where the trending card result includes, for a second-user selectable link, a second access mechanism: that is associated with an application that is executable by the user device; and that, when executed by the user device, causes the user device to transition the application to a specific state that provides content related to the trending keyword; and transmitting the trending card result to the user device with the keyword card results, where, in response to user selection of the second user-selectable link, the user device executes the second access mechanism of the trending card result.

In further features, the instructions further include instructions for replacing one of the keyword card results with the trending card result.

In a feature, a non-transitory computer-readable medium stores instructions for execution by one or more processors of a search system, the instructions include instructions for: receiving, from a user device, a webpage keyword for a webpage navigated to by the user device; based on the webpage keyword, selecting keyword card results from a plurality of keyword card results stored in a data store, where each keyword card result of the keyword card results includes, for a respective user-selectable link for display by the user device, a respective access mechanism: that is associated with an application that is executable by the one or more processors of the user device; and that, when executed by the user device, causes the user device to transition the application to a specific state that provides content related to the webpage keyword; and, transmitting the keyword card results to the user device, where, in response to user selection of the user-selectable links, the user device executes the respective access mechanisms of the respective keyword card results.

In further features, the instructions further include instructions for: selecting a trending card result based on a trending keyword, where the trending card result includes, for a second user-selectable link, a second access mechanism: that is associated with an application that is executable by the user device; and that, when executed by the user device, causes the user device to transition the application to a specific state that provides content related to the trending keyword; and transmitting the trending card result to the user device with the keyword card results, where, in response to user selection of the second user-selectable link, the user device executes the second access mechanism of the trending card result.

In further features, the instructions further include instructions for replacing one of the keyword card results with the trending card result.

In a feature, a non-transitory computer-readable medium stores instructions for execution by one or more processors of a user device, the instructions include instructions for: receiving a search string to be searched for by a search engine; obtaining from a search engine a search engine results page (SERP) for the search string; displaying the SERP on a display of the user device; transmitting the search string to a search system that is separate from the search engine; receiving keyword card results from the search system selected based on the search string, where each keyword card result of the keyword card results includes, for a respective user-selectable link, a respective access mechanism: that is associated with an application that is executable by the one or more processors; and that, when executed by the one or more processors, cause the one or more processors to transition the application to a specific state that provides content related to the search string; concurrently with displaying the SERP, displaying on the display of the user device, the user-selectable links for the keyword card results, respectively; and in response to user selection of the user-selectable links, executing the respective access mechanisms of the respective keyword card results.

In further features, the instructions further include instructions for obtaining the search string from a portion of a URL of the SERP.

In further features, the instructions further include instructions for obtaining the search string from a search field of a webpage of the search engine.

In further features, the instructions further include instructions for obtaining the search string from a search field of an application being executed by the one or more processors.

In further features, the instructions further include instructions for: receiving a trending card result from the search system selected based on a trending keyword, where the trending card result includes, for a second user-selectable link, a second access mechanism: that is associated with an application that is executable by the one or more processors of the user device; and that, when executed by the one or more processors, causes the one or more processors to transition the application to a specific state that provides content related to the trending keyword; displaying on the display of the user device the second user-selectable link for the trending card result; and in response to user selection of the second user-selectable link executing the second access mechanism of the trending card result.

In further features, the instructions further include instructions for replacing on the display one of the user-selectable links for the keyword card results with the second user-selectable link for the trending card result.

In further features: the instructions for each keyword card result of the keyword card results include data associated with an image and data associated with text; and the instructions further include instructions for displaying on the display the images and the text of the keyword card results with the user-selectable links, respectively.

In further features, the instructions for displaying on the display, the user-selectable links for the keyword card results, respectively, include instructions for displaying the user-selectable links only in response to receipt of predetermined user input to display the user-selectable links.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

FIG. 1A is a schematic view of an example environment including a user device and a search system.

FIG. 1B is a schematic view of an example user device in communication with the search system.

FIG. 2 is a schematic view of an example user device.

FIG. 3A is a schematic view of an example user device executing an add-on module in communication with a search system.

FIG. 3B is a schematic view of an example add-on module.

FIG. 4A is a schematic view of an example user device and add-on module in communication with a search system.

FIG. 4B is a schematic view of an example search system receiving a uniform resource locator.

FIG. 4C is a schematic view of an example search system receiving a search query.

FIG. 4D is a schematic view of an example search system receiving a uniform resource locator and obtaining a trending keyword.

FIG. 4E is a schematic view of an example search system and an example card record.

FIG. 4F is a schematic view of an example card record.

FIG. 5 is an example arrangement of operations for obtaining search results from a webpage keyword.

FIG. 6 is an example arrangement of operations for obtaining search results from a webpage keyword or a search query.

FIG. 7 is a schematic view of an example computing device executing any systems or methods described herein.

FIGS. 8 and 9 are example arrangements of operations for obtaining search results.

Like reference symbols in the various drawings indicate like elements.

### DETAILED DESCRIPTION

The present disclosure provides a system and method for delivering search results based on web browsing activities of a user. An add-on module may capture a user's web inputs into a tool bar or search field within a web browser as a search string and send the user's web inputs to a search system. The search system determines whether the search string is a uniform resource locator (URL) or a search query. If the search string is a URL, the search system parses the webpage at the URL to determine webpage keywords. Webpage keywords may be obtained using rapid automatic keyword extraction or through parsing and scouring the webpage keywords. Once the webpage keyword has been obtained, the search system searches card records to determine card results related to the webpage keyword. In some examples, trending keywords from external data sources are also used to generate card results. If the search string is a search query, the search system searches card records to determine card results related to the search query. The card results are returned to the add-on module. The add-on module may display the card results when an image is accessed or the add-on module may directly display the card results. A description of an example implementation illustrating the principles of the present disclosure is provided below.

### System Overview

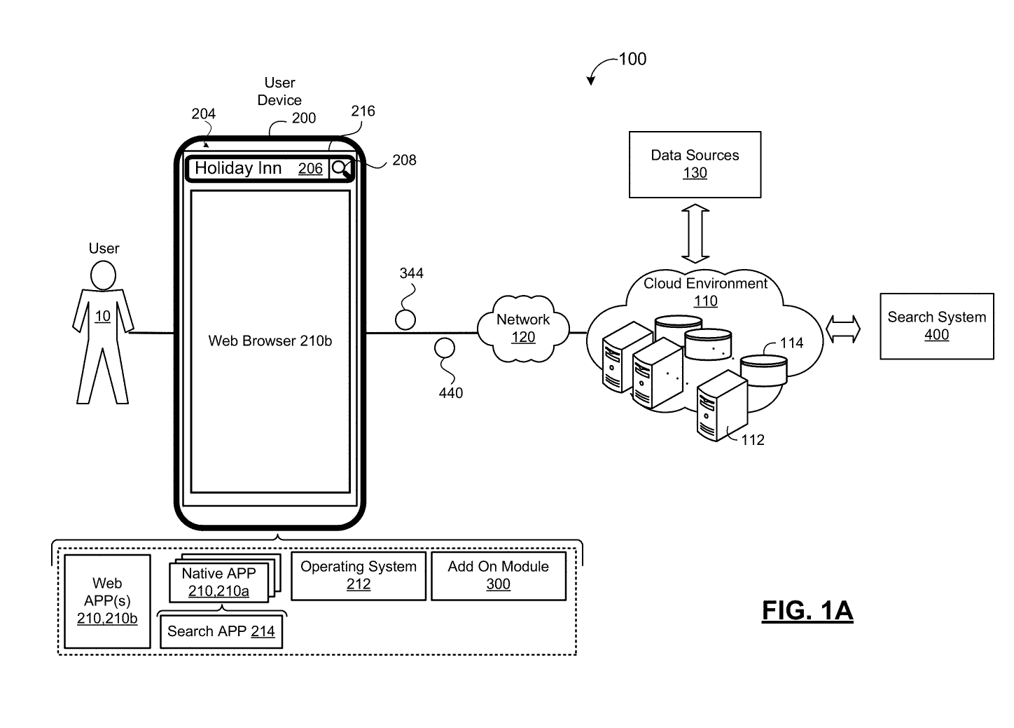

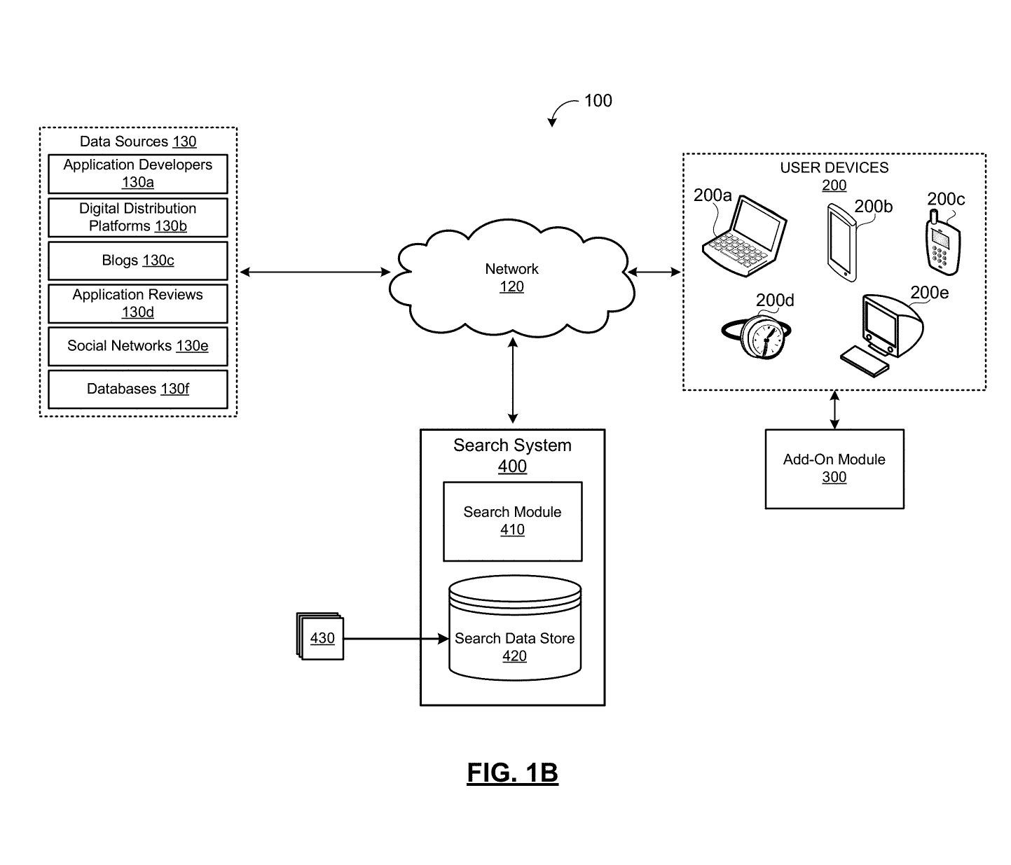

FIG. 1A illustrates an example system 100 that includes a user device 200 associated with a user 10 in communication with a remote system 110 via a network 120. FIG. 1B provides a functional block diagram of the system 100. The remote system 110 may be a distributed system (e.g., cloud environment) having scalable/elastic computing resources (data processing hardware, including one or more processors) 112 and/or storage resources 114. The user device 200 and/or the remote system 110 may implement a search system 400 and optionally receive data from one or more data sources 130. In some implementations, the search system 400 communicates with the user device 200 and the data source(s) 130 via the network 120. The network 120 may include various types of networks, such as a local area network (LAN), wide area network (WAN), and/or the Internet.

In general, the user device 200 includes an add-on module 300 that communicates with the search system 400 and that is an add-on (program) to a software application 210 that transmits search strings 340 to the search system 400.

In some examples, the add-on module 300 is an add-on to one of a plurality of native applications 210a that is dedicated to interfacing with the search system 400, such as a native application (e.g., a search application 214) that is dedicated to sending search queries to the search system 400 and displaying resulting search engine results pages (SERPs). In some examples, the add-on module 300 is an add-on to another type of application that is not dedicated to interfacing with the search system 400, such as a web browser application 210b. An example of the web browser application 210b includes Firefox by Mozilla. The add-on module 300 may be installed as part of the web browser application 210b installation package or can be installed separately from the installation of the web browser application 210b.

Although the user device 200 may also communicate with the search system 400 using one of the native applications 210a and/or the web browser application 210b, the user device 200 may be described hereinafter as using the add-on module 300 to communicate with the search system 400. Also, while the add-on module 300 is referred to herein as an add-on, the add-on module 300 can also be referred to as an add-in, a plug-in, or an extension (including WebExtensions). Add-ons, add-ins, plug-ins, and extensions are programs that execute within, and add one or more features to, another program (e.g., the search application 214, another one of the native applications 210a, or the web browser application 210b). In the example of the add-on module 300 being an add-on to the Firefox web browser application, the add-on module 300 may be lightweight (e.g., less than 300 kilobytes), include javascript, and use the Firefox add-on software development kit (SDK).

The search system 400 can be implemented in a variety of different ways. In the example shown, the search system 400 searches across a variety of different applications 210 and verticals (e.g., web, images, video, etc.). The search system 400 may be in communication with one or more third party applications, having corresponding app-specific functions or applications functions necessary to be accessed by the user device 200 or the search system 400 via the network 120. In some implementations, the search system 400 includes a search module 410 in communication with a search data store 420. The search data store 420 may include one or more databases, indices (e.g., inverted indices), tables, files, or other data structures, which may be used to implement the techniques of the present disclosure.

Generally speaking, the search module 410 receives a search string 340 from the user device 200 and performs a search for card records 430 included in the search data store 420 based on the search string 340. The search module 410 generates search results 440 based on data included in the search data store 420 (e.g., the card records 430 identified based on the search string 340) and transmits the search results 440 to the user device 200. In various implementations, advertisers may pay an operator of the search system 400 for inclusion of ones of the card records 430 in the search results and/or for user accessing content associated with the ones of the card records 430.

The search module 410 may access one or more data sources 130 while executing the search or identifying ones of the card records 430. The data sources 130 may be sources of data, which the search system 400 (e.g., the search module 410) may use to generate and update data stored in the search data store 420, such as ones of the card records 430. The data retrieved from the data sources 130 can include any type of data related to application functionality and/or application states. Data retrieved from the data sources 130 may be used to create and/or update one or more databases, indices, tables (e.g., an access table), files, or other data structures included in the search data store 420. For example, the search system 400 may create and update ones of the card records 430 based on data retrieved from the data sources 130. In some examples, some data included in a data source may be manually generated by a human operator. Data included in the card records 430 may be updated over time so that the search system 400 provides up-to-date search results.

The data sources 130 may include a variety of different data providers. For example, the data sources 130 may include application developers 130a, such as application developers' websites and data feeds provided by application developers. The data sources 130 may include operators of one or more digital distribution platforms 130b configured to distribute the native applications 210a to user devices 200. Examples of the digital distribution platforms 130b include, but are not limited to, the GOOGLE PLAY® digital distribution platform by Google, Inc., the APP STORE® digital distribution platform by Apple, Inc., and WINDOWS PHONE® Store developed by Microsoft Corporation.

The data sources 130 may additionally or alternatively include other websites, such as websites that include web logs 130c (i.e., blogs), application review websites 130d, and/or other websites including data related to applications. The data sources 130 may additionally or alternatively include social networking sites 130e, such as “FACEBOOK®” by Facebook, Inc. (e.g., Facebook posts) and “TWITTER®” by Twitter Inc. (e.g., text from tweets). The data sources 130 may additionally or alternatively include one or more online databases 130f that include, but are not limited to, data related to movies, television programs, music, and restaurants. The data sources 130 may additionally or alternatively include additional types of data sources in addition to the data sources described above. Different ones of the data sources 130 may have their own content and update rate.

### User Device

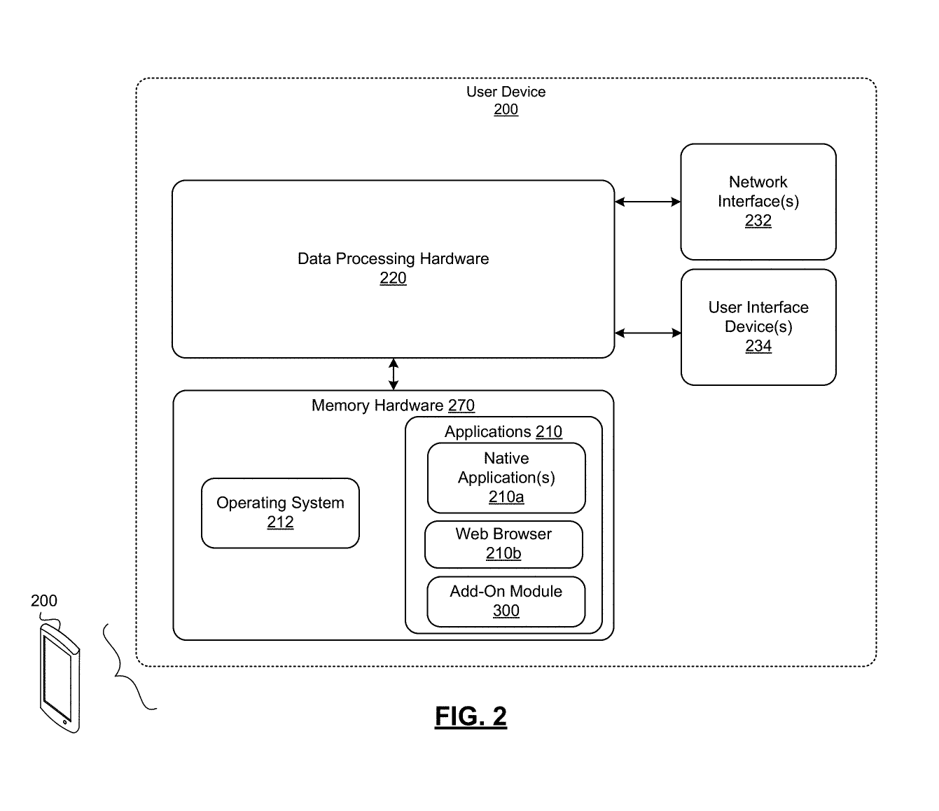

FIG. 2 shows an example of the user device 200. The user device 200 is a computing device configured to provide search queries, such as search query 344, to the search system 400. Examples of user devices include, but are not limited to, mobile computing devices, such as laptops 200a, tablets 200b, and smart phones 200c, and wearable computing devices 200d, such as headsets and watches. Other examples of user devices include other computing devices having other form factors, such as computing devices included in desktop computers 200e, vehicles, gaming devices, televisions, or other appliances (e.g., networked home automation devices and home appliances).

The user device 200 may execute one or more software applications 210. A software application may refer to computer software that, when executed by a computing device, causes the computing device to perform a task. In some examples, a software application is referred to as an “application”, an “app”, or a “program”. Examples the software applications 210 include, but are not limited to, word processing applications, spreadsheet applications, messaging applications, media streaming applications, social networking applications, and games. In some examples, ones of the software applications 210 are installed on the user device 200 prior to the user 10 purchasing the user device 200. Additionally or alternatively, ones of the software applications 210 may be downloaded and installed on the user device 200.

The user device 200 may use a variety of different operating systems, such as operating system 212. In examples where the user device 200 is a mobile device, the user device 200 may run an operating system including, but not limited to, ANDROID® developed by Google Inc., 10S® developed by Apple Inc., or WINDOWS PHONE® developed by Microsoft Corporation. Accordingly, the operating system 212 running on the user device 200 may include, but is not limited to, one of ANDROID®, IOS®, or WINDOWS PHONE®. In an example where the user device 200 is a laptop or desktop computing device, the user device 200 may run an operating system including, but not limited to, MICROSOFT WINDOWS® by Microsoft Corporation, MAC OS® by Apple, Inc., or Linux. User devices may also access the search system while running operating systems other than those operating systems described above, whether presently available or developed in the future.

In the example shown, the user device 200 includes data processing hardware 220 in communication with memory hardware 270, one or more network interface devices 232, and one or more user interface devices 234. The user device 200 may also include other components not explicitly depicted. The data processing hardware 220 may include one or more processors. In implementations where the data processing hardware 220 includes two or more processors, the processors can execute in a distributed or individual manner.

The memory hardware 270 (e.g., random access memory (RAM), read-only memory (ROM), hard disk drive, and/or flash memory) stores instructions that, when executed by the data processing hardware 220, cause the data processing hardware 220 to perform one or more operations. The memory hardware 270 may store computer readable instructions that make the native applications 210a, the web browser application 210b, and/or the operating system 212. The operating system 212 acts as an interface between the data processing hardware 220 and the software applications 210.

The network interface devices 232 include one or more devices configured to communicate with the network 120. The network interface devices 232 can include one or more transceivers for performing wired and/or wireless communication. Examples of the network interface devices 232 may include, but are not limited to, a transceiver configured to perform communications using the IEEE 802.11 wireless standard, another type of wireless transceiver, an Ethernet transceiver configured to communicate over an Ethernet cable, and a universal serial bus (USB) transceiver.

The user interface devices 234 include one or more devices configured to receive input from and/or provide output to the user 10. The user interface devices 234 can include, but are not limited to, a touchscreen display 216, a non-touchscreen display, a QWERTY keyboard, another type of keyboard, a numeric keypad, a touchpad, a microphone, one or more speakers, and/or one or more other types of user interface devices.

### Add-on Module

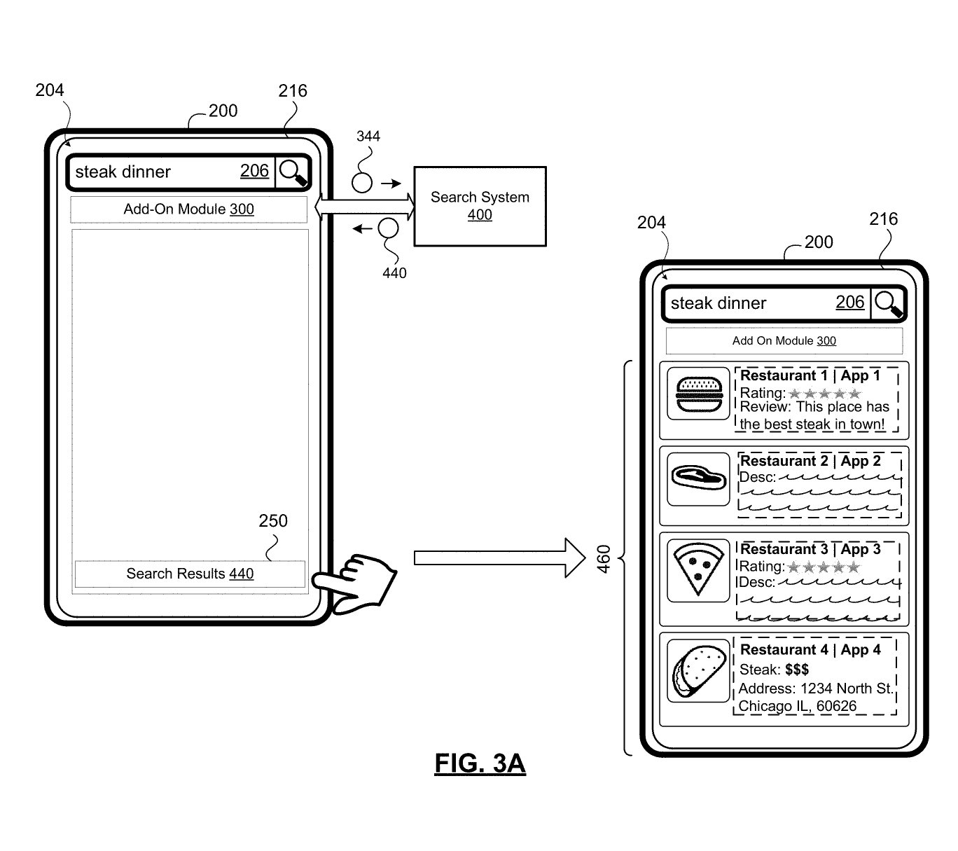

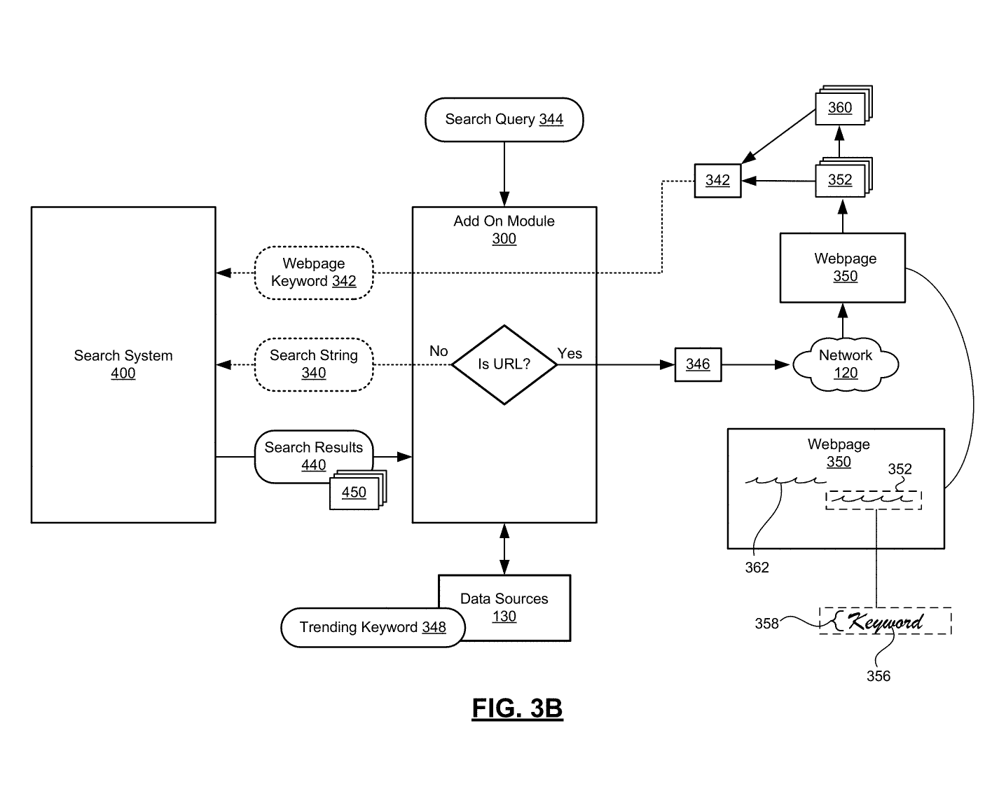

FIG. 3A illustrates the user device 200 displaying a graphical user interface (GUI) 204 during execution of the search application 214 and the add-on module 300 as an add-on to the search application 214. In the example of FIG. 3A, the GUI 204 has an input field 206 and a search button 208, and a display portion for the add-on module 300, which is discussed further below.

The user device 200 receives the search string 340 from the user 10 via the input field 206 of the GUI 204. When the user 10 inputs the search string 340 and requests a search (e.g., via clicking the search button 208), the search application 214 generates a search query 344 and transmits the search query 344 to the search system 400. The search application 214 may include the search string 340 and other data in the search query 344. The user 10 may enter the search string 340, for example, using a touchscreen keypad displayed on the display 216, a mechanical keypad, or a speech-to-text program (via a microphone of the user device 200). Other methods of inputting the search string 340 are possible as well. In response to receipt of the search query 344, the search system 400 generates the search results 440 for the search query 344. The search application 214 displays a SERP (search engine results page) including the search results 440 in the GUI 204. For example only, the SERP may include user-selectable links for the search results 440, respectively.

The add-on module 300 also obtains the search string 340. For example, the add-on module 300 may copy the search string 340 from the search query 340 or from the input field 206 of the GUI 204. The add-on module 300 may send the search string 340 to the search system 400. While the example of the add-on module 300 sending the search string 340 to the search system 400 is provided, the add-on module 300 may send the search string 340 to another search system that is different than the search system 400 that generates the search results 440.

The search system 400 (receiving the search string 340 from the add-on module 300) identifies relevant ones of the card records 430 based on correspondence between data stored in the card records 430 and the search string 340. The search system 400 transmits the search results 440 for the search query 344 to the user device 200.

The user device 200 (specifically the search application 214) may continue to display the SERP for the search query 344. The add-on module 300 also displays an add-on portion 250 on the display 216. The add-on module 300 may, for example, overlay the add-on portion 250 over a portion of the SERP, such as at a predetermined location at a bottom of the SERP. This allows the user 10 to operate the search application 214 and view the SERP with minimal disruption.

The add-on module 300 displays the add-on portion 250 to indicate to the user 10 that other relevant search results are available. Upon the user 10 selecting (e.g., touching) or moving a cursor over the add-on portion 250, the add-on module 300 increases one or more dimensions of the add-on portion 250 and displays complete add-on search results to the user 10 on the display 216. This allows search results 440 to be available to the user 10 without interrupting the normal experience of the user 10 during use of the search application 214.

The add-on module 300 functions similarly during execution of the web browser application 210b. The web browser application 210b can be used, for example, to navigate from webpage to webpage. Each webpage has a corresponding Uniform Resource Locator (URL).

Each time the web browser application 210b accesses a webpage, the web browser application 210b generates a search query 344 and transmits the search query 344 to the search system 400. The web browser application 210b may include the URL of the webpage and other data in the search query 344. In response to receipt of the search query 344, the search system 400 generates the search results 440 for the search query 344. The web browser application 210b displays the webpage in the GUI 204.

The add-on module 300 also obtains the URL of the webpage. For example, the add-on module 300 may copy the URL from the search string 340 or from the input field 206 of the GUI 204. The add-on module 300 may send the URL to the search system 400. Alternatively, the add-on module 300 may determine one or more keywords for the webpage (e.g., from the document object model (DOM) of the webpage) and transmit the keyword(s) to the search system 400. While the example of the add-on module 300 sending the URL or the keyword(s) to the search system 400 is provided, the URL may send the URL or the keyword(s) to another search system that is different than the search system 400 that generates the search results 440.

In the example where the add-on module 300 transmits the URL, the search system 400 determines the one or more keywords for the webpage (e.g., from the document object model (DOM) of the webpage). The search system 400 identifies relevant ones of the card records 430 based on correspondence between data stored in the card records 430 and the keyword(s). The search system 400 transmits the search results 440 for the search query 344 to the user device 200.

The user device 200 (specifically the web browser application 210b) may continue to display the webpage. The add-on module 300 also displays the add-on portion 250 on the display 216. The add-on module 300 may, for example, overlay the add-on portion 250 over a portion of the webpage, such as in the predetermined location at a bottom of the webpage. This allows the user 10 to operate the web browser application 210b and view the webpage with minimal disruption.

The add-on module 300 displays the add-on portion 250 to indicate to the user 10 that other relevant search results are available. Upon the user 10 selecting (e.g., touching) or moving a cursor over the add-on portion 250, the add-on module 300 increases one or more dimensions of the add-on portion 250 and displays the add-on search results to the user 10 on the display 216. This allows the add-on search results to be available to the user 10 without interrupting the normal experience of the user 10 during use of the web browser application 210b.

Referring to FIG. 3B, in some implementations, the add-on module 300 receives the search query 344 and determines whether the search query 344 includes a URL 346 of a webpage or a search string 340 (of text) by examining a formatting of the search query 344. For example, the add-on module 300 can identify that a URL is present based on the search query 344 having distinct formatting requirements, including but not limited to, “www.”, “HTTP://”, “.com”, and/or “.org”, etc. If the search query 344 includes a URL (and not a search string), the add-on module 300 may access the webpage 350 using the URL 346 and may parse the webpage 350 for candidate keywords 352. The candidate keywords 352 indicate likely one or more webpage keywords 342 that are representative of the content of the webpage 350. The add-on module 300 may determine the candidate keywords 352, for example, using Rapid Automatic Keyword Extraction (RAKE) 354. In some examples, the add-on module 300 parses the webpage 350 for the candidate keywords 352 to determine the webpage keyword(s) 342. The candidate keywords 352 may each be assigned a word score 360. The add-on module 300 may determine the word score 360 of a candidate keyword based on, but not limited to, a location of the candidate keyword, a font type 356, a font size 358, and a frequency of appearance of the candidate keyword in the webpage 350. The frequency of appearance (or usage) of a candidate keyword may be, for example, the total number of times that the candidate keyword appears on the webpage 350, the total number of times that the candidate keyword appears on the webpage 350 divided by a total number of all words of the webpage 350, etc. The add-on module 300 may compare the candidate keywords 352 to the title 362 of the webpage 350. The add-on module 300 may select the webpage keyword(s) 342 based on any of the above factors and/or the word scores 360 of the candidate keywords 352. For example, the add-on module 300 may select one or more of the candidate keywords 352 with respective word scores that are greater than a predetermined score value and/or a predetermined number (e.g., 2 or 3) of the candidate keywords 352 that have the greatest word scores.

Once the add-on module 300 has selected the webpage keyword(s) 342, the add-on module 300 sends the webpage keyword(s) 342 to the search system 400 in the search query 344. For a search string, the add-on module 300 sends the search string in the search query 344. The search system 400 determines the search results 440, which include card results 450, based on the received webpage keyword(s) 342 or the search string 340 and returns the search results 440 to the add-on module 300.

In some implementations, the add-on module 300 accesses the data sources 130 to determine one or more trending keywords 348. The trending keyword(s) 348 may be related to current events, or other indicators for popular activities. The trending keyword(s) 348 may be trending as related to the user 10 and the activities of the user 10. The add-on module 300 may send the trending keyword(s) 348 to the search system 400 and obtain card results 450 related to the trending keyword(s) 348. One or more of the card results 450 related to the trending keyword(s) 348 may be used to replace one or more of the card results 450 related to the webpage keyword(s) 342. The trending keyword(s) 348 may be assigned a trending keyword relevance score 366 by comparing the trending keyword(s) 348 to the webpage keyword(s) 342. In some examples, if the trending keyword relevance score 366 of a trending keyword satisfies a threshold value 368, the add-on module 300 may replace one or more of the card results 450 related to the webpage keyword(s) 342 with one or more of the card results 450 related to the trending keyword(s) 348.

### Search System

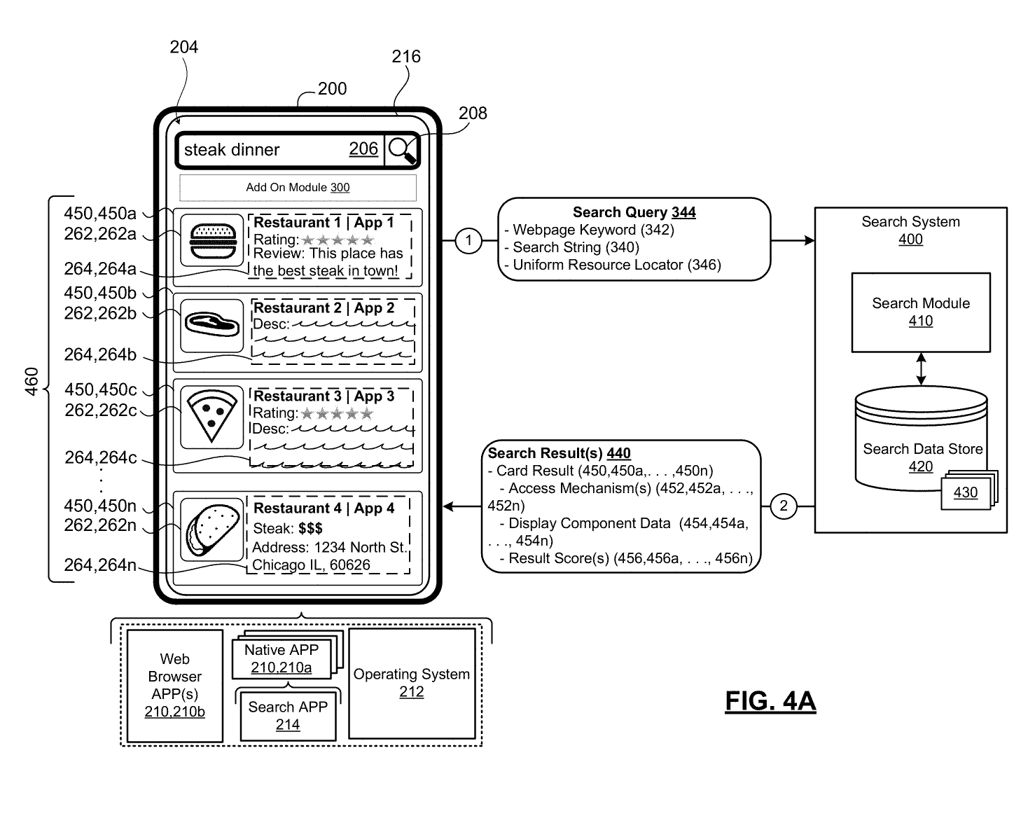

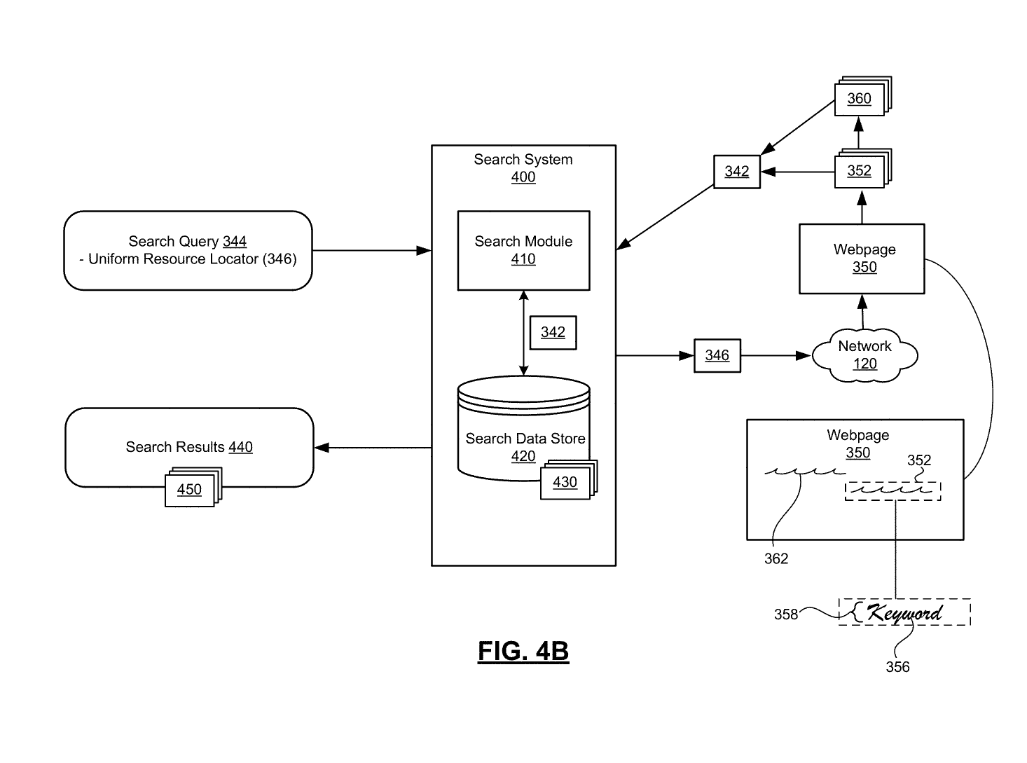

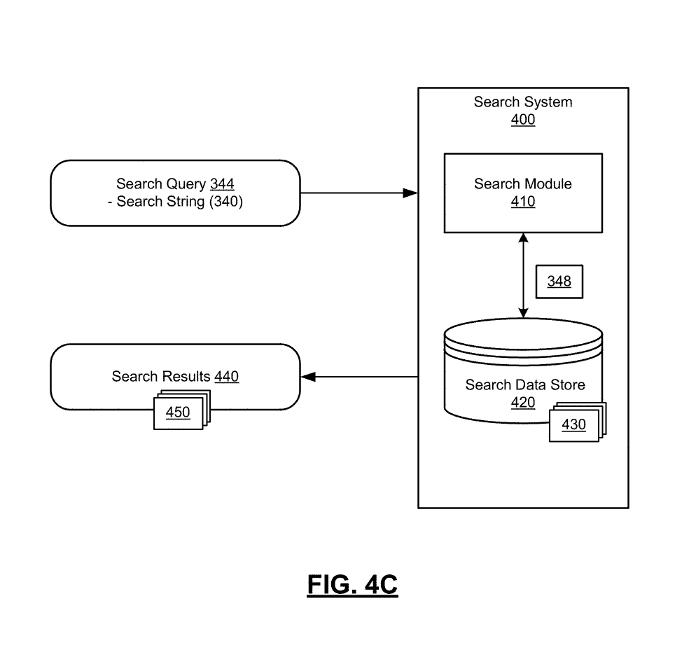

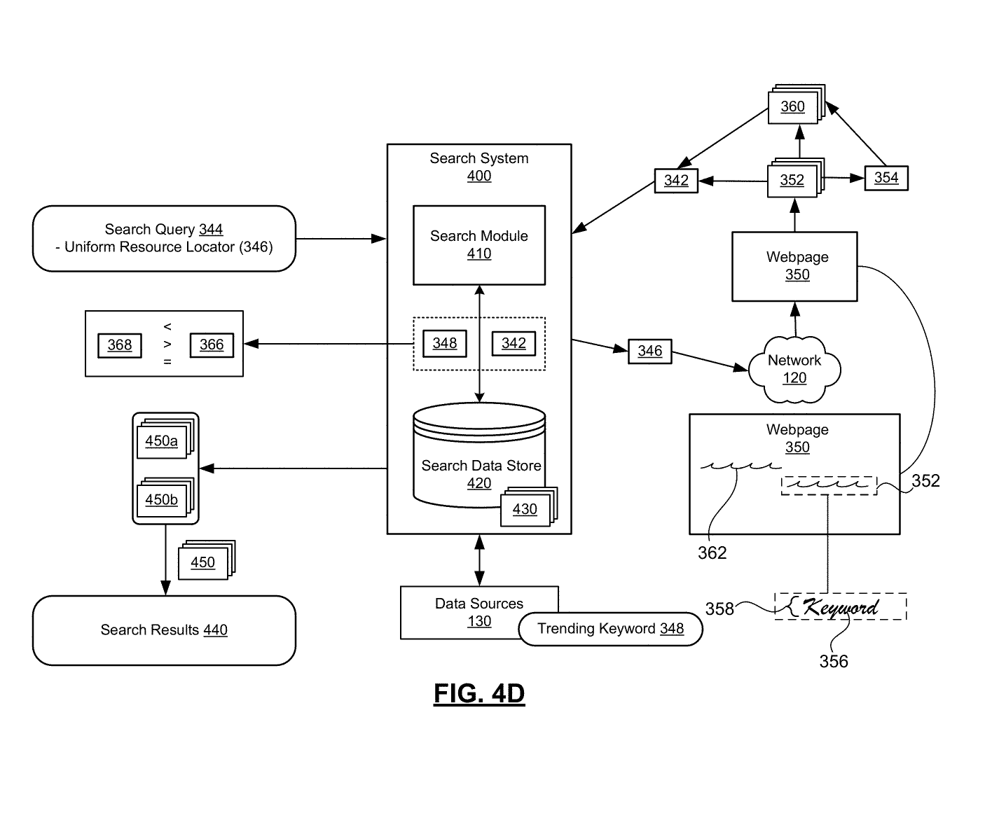

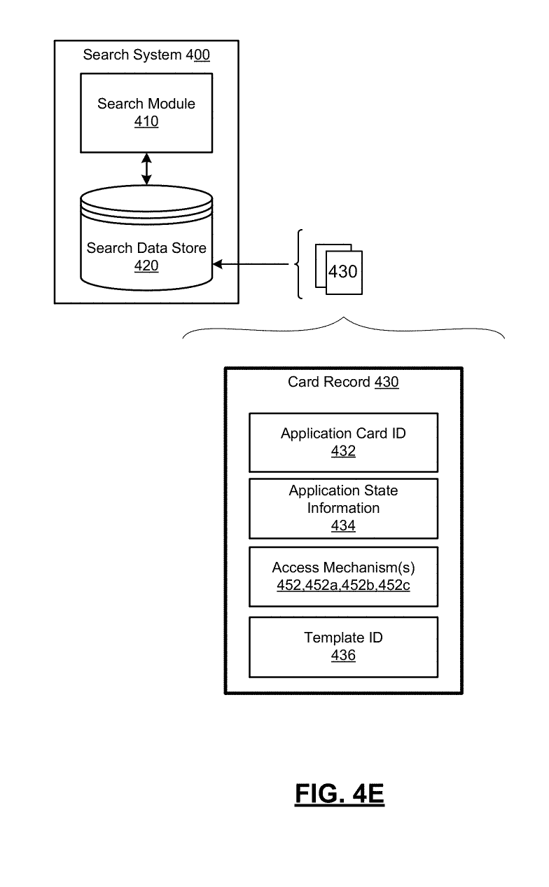

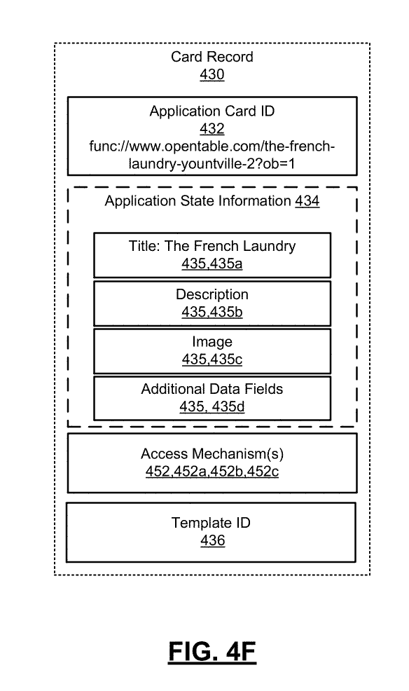

Referring to FIG. 4A, in some implementations, in response to receiving the search query 344, the search system 400 determines whether the search query 344 includes the search string 340 or the URL 346. The search system 400 implements a search based on whether the search query 344 includes the search string 340 or the URL 346 and generates the search results 440 accordingly.

The search module 410 generates the search results 440 based on the search query 344 and data included in the search data store 420 and transmits the search results 440 to the user device 200. The search system 400 may also generate the search results 440 based on data from one or more of the data sources 130, as shown in FIG. 1B, relevant to the search query 344.

The user device 200 receives and renders the search results 440 on the display 216 of the user device 200 as card results 450a-n (“card results 450”). For example, in the case of the search query 344 including the search string 340, the user device 200 may display a SERP including user selectable links for the search string 340. In the case of the search query 344 including the URL 346, the user device 200 may render and display the webpage corresponding to the URL 346.

The search results 440 include card results (objects) 450. Each of the card results 450 includes one or more access mechanisms 452a-n (“access mechanisms 452”), display component data 454a-n (display component data 454″) for one or more display components, and optionally result scores 456a-n (“result scores 456”) indicating respective ranks or scores of the card results 450. The user device 200 can use the one or more of the access mechanisms 452 to access different functions for a variety of different applications 210, such as the native applications 210a installed on the user device 200. The result score 456 associated with each of the search results 440 may indicate the relevance of that one of the search results 440 to the search string 340 (e.g., in order to rank each search results 440) or the webpage keyword(s) 342. A higher result score 456 may indicate that the search results 440 are more relevant to the search string 340 or the webpage keyword(s) 342.

Each of the card results 450 includes a result object. For example, each of the card results 450 include or be a user-selectable result link 460 (also referred to as a “link”) associated with one of the access mechanisms 452 of the corresponding result object. Moreover, the user device 200 may display each of the card results 450 using the display component data 454 of the corresponding result object (e.g., included in the search results 440). The user device 200 uses the display component data 454 to render one or more display components as the user-selectable links 460 associated with the card results 450. Furthermore, the search application 214 or web browser application 210b may arrange the card results 450 in an order based on the result scores 456 associated with the access mechanisms 452 included in the card results 450, such as highest result score to lowest result score.

As stated above, each of the card results 450 includes display component data 454. The display component data 454 of one of the card results 450 may be an image 262 (e.g., an icon), text 264 (e.g., an application or business name) that may describe an application 210 and a state of the application 210, or other data. In the example shown, the card results 450 include respective images 262a-n and text 264a-n; however, other examples are possible as well, where the card result 450 includes only the respective images 262a-n or only the respective text 264a-n, for example.

Each of the card results 450 may include an access mechanism 452 so that when the user 10 selects one of the card results 450 (e.g., via its user-selectable link 460), the user device 200 launches an associated one of the applications 210 and sets the application 210 into a state specified by the access mechanism 452. In some examples, the user 10 selects the user-selectable link 460 by interacting with the link 460 (e.g., touching or clicking the link). In response to selection of the link 460, the user device 200 launches an associated one of the applications 210 (e.g., one of the native applications 210a or the web browser application 210b) referenced by the access mechanism 452 and performs one or more operations indicated in the access mechanism 452 to enter an application state associated with the access mechanism 452.

The access mechanisms 452 may include at least one of a native application access mechanism 452a (hereafter “application access mechanism”), a web access mechanism 452b, and an application download mechanism 452c. The user device 200 may use the access mechanisms 452 to access functionality of the applications 210. For example, the user 10 may select one of the user-selectable links 460 including one of the access mechanisms 452 in order to access functionality of one of the software applications 210 indicated in the one of the user-selectable links 460. The search system 400 may transmit one or more of the access mechanisms 452, such as one or more application access mechanisms, one or more web access mechanisms, and/or one or more application download mechanisms, to the user device 200 in the search results 440.

Each application access mechanism, such as the application access mechanism 452a, may be a string that includes a reference to one of the native applications 210a and indicates one or more operations for the user device 200 to perform. When the user 10 selects one of the user-selectable links 460 including an application access mechanism, the user device 200 launches the one of the native applications 210a referenced in the application access mechanism and performs the one or more operations indicated in the application access mechanism to transition the one of the native applications 210a to transition the one of the native applications 210a to a specific state.

Each web access mechanism, such as the web access mechanism 452b, may include a resource identifier that includes a reference to a web resource (e.g., a page of a web application/website). For example, a web access mechanism may include a uniform resource locator (URL) (i.e., a web address) used with hypertext transfer protocol (HTTP). When the user 10 selects one of the user-selectable links 460 including a web access mechanism, the user device 200 may launch the web browser application 210b and retrieve the web resource indicated in the resource identifier of the web access mechanism. Put another way, when the user 10 selects one of the user-selectable links 460 including a web access mechanism, the user device 200 launches the corresponding web browser application 210b and accesses a specific state (e.g., a webpage) of a web application or website. In some examples, web access mechanisms include URLs for mobile-optimized sites and/or full sites.

A web access mechanism included in one of the card results 450 may be used by the web browser application 210b to access a web resource (e.g., a URL) that includes similar information and/or performs similar functions as would be performed by one of the native applications 210a that receives an application access mechanism of an application state record. For example, a web access mechanism of one of the card results 450 may direct the web browser application 210b of the user device 200 to a web-version of one of the native applications 210a referenced in an application access mechanism of that one of the card results 450. Moreover, if the application access mechanisms included in one of the card results 450 for a specific Mexican restaurant causes one of the native applications 210a to retrieve information for the specific Mexican restaurant, the web access mechanism may direct the web browser application 210b of the user device 200 to a specific webpage entry for that specific Mexican restaurant.

Each application download mechanism, such as the application download mechanism 452c, may indicate a location (e.g., the one of the digital distribution platforms 130b) where an associated one of the native applications 210a can be downloaded in the scenario where that native application is not presently installed on the user device 200. When the user 10 selects one of the user-selectable links 460 including an application download mechanism, the user device 200 accesses a digital distribution platform from which the associated native application may be downloaded. The user device 200 may access the one of the digital distribution platforms 130b using at least one of the web browser application 210b and one of the native applications 210a.

FIG. 4B illustrates the example of the search system 400 receiving the search query 344 including the URL 346. The search module 410 retrieves the webpage 350 located at the URL 346 via the network 120. Upon retrieving the webpage 350, the search module 410 determines the webpage keyword(s) 342 for the webpage 350.

The search module 410 may determine the webpage keyword(s) 342, for example, by parsing the text 264 or source code of the webpage 350. For example, the search module 410 may determine the webpage keyword(s) 342 by parsing the document object model (DOM) of the webpage 350. The search module 410 may parse multiple candidate words 352 from the webpage 350 before selecting the one or more webpage keyword(s) 342 for the webpage 350.

Generally, the webpage keyword(s) 342 summarize a key relevance of the webpage 350 and what is most likely relevant to the user 10. The search module 410 may obtain the webpage keyword(s) 342 using a RAKE algorithm 354 to extract the webpage keyword(s) 342 from the webpage 350.

In some examples, the RAKE algorithm 354 works by first determining multiple candidate keywords for the webpage 350. The RAKE algorithm 354 may one or more of the candidate keywords, such as the ones having a highest frequency of appearance on the webpage 350, as the webpage keyword(s) 342. In some examples, the search module 410 parses the webpage 350 for candidate keywords and the search module 410 assigns each candidate keyword a word score 360. The word score 360 of a candidate keyword indicates a likelihood of that candidate keyword representative of the overall content of the webpage 350. The search module 410 may alter the word score 360 for each candidate keyword based on the location, font size 358, the font type 356 (e.g. bold, italics, or typeset), and/or the frequency of appearance for that candidate keyword 352 on the webpage 350. The search module 410 may select one or more of the candidate keyword(s) with the highest word scores as the webpage keyword(s) 342.

After the search module 410 has determined the candidate keywords for the webpage 350, the search module 410 may compare the candidate keywords with a title 362 of the webpage 350. The title 362 may be obtained via the DOM of the webpage 350. Generally speaking, the title 362 may be indicated on the webpage 350 by HTML code or though other identifiers that are readable by the search module 410.

After determining the webpage keyword(s) 342, the search module 410 accesses the search data store 420 and retrieves ones of the card records 430 related to the webpage keyword(s) 342. The search module 410 returns the ones of the card records 430 as the search results 440 to the add-on module 300.

As an example, consider the case where the web browser application 210b accesses and displays the webpage 350 at the URL of www.airplane.com. The add-on module 300 sends the URL of “www.airplane.com” to the search system 400. The search system 400 retrieves the webpage 350 located at the URL “www.airplane.com” via the network 120. The search module 410 parses the webpage 350 located at “www.airplane.com” and finds the words “Piper”, “Flights”, and “Helicopter” appear with a high frequency on the webpage 350. The search module 410 assigns the words “Piper”, “Flights”, and “Helicopter” as candidate keywords, and the search module 410 assigns the candidate keywords respective word scores. The search module 410 determines that the “Flights” candidate keyword appears in a larger font size, a bold font type, and three times as frequently as the other candidate keywords “Piper” and “Helicopter.” Based on the other candidate keywords appearing less frequently, in smaller font sizes, and/or not being bolded, the search module 410 may increase the word score for the “Flights” candidate keyword relative to the word scores for the “Piper” and “Helicopter” candidate keywords. The search module 410 may determine that the “Flights” candidate word has the highest word score of all of the candidate words. As such, the search module 410 may select the “Flights” candidate word as the webpage keyword(s) 342 for the webpage 350 located at the URL “www.airplane.com.”

The search module 410 accesses the search data store 420 and retrieves ones of the card records 430 related to the keyword “Flights”, such as ones of the card records 430 for airline tickets and travel destinations, and returns the related ones of the card records 430 as the card results 450. The card results 450 related to “Flights” are returned to the add-on module 300 as search results 440. The add-on module 300 displays the add-on portion 250 overlaying the webpage 350 at the URL of www.airplane.com. In response to the user interacting with the add-on portion 250 (e.g., by touching, clicking, or hovering a cursor over the add-on portion 250), the add-on module 300 increases one or more dimensions (e.g., height, width) of the add-on portion 250 and displays the search results 440 within the add-on portion 250 overlaying the webpage 350.

FIG. 4C illustrates the search system 400 receiving the search query 344 containing the search string 340. The search system 400 generates a SERP corresponding to the search string 340, and the user device 200 displays the SERP for the search string 340 on the display 216.

The search module 410 differentiates the search string 340 from a URL because of the lack of proper formatting of a URL. URLs have a specific format in order for the to be valid URLs. Any search string not in the proper format may be considered a search string and not a URL. Indicators that may be used to differentiate search strings from URLs include, but are not limited to, URLs including “www.”, “HTTP://”, “.com”, and/or “.org”, etc. When the search module 410 receives the search query 344, the search module 410 references the search data store 420 to retrieve ones of the card records 430 related to the search string 340. The search system 400 returns the ones of the card results 450 to the add-on module 300 as the search results 440. The add-on module 300 displays the add-on portion 250 overlaying the SERP including search results for the search string 340. In response to the user interacting with the add-on portion 250 (e.g., by touching, clicking, or hovering a cursor over the add-on portion 250), the add-on module 300 increases one or more dimensions (e.g., height, width) of the add-on portion 250 and displays the search results 440 within the add-on portion 250 overlaying the SERP.

FIG. 4D illustrates the search system 400 receiving the search query 344, obtaining one or more trending keywords 348, and generating the search results 440. The trending keywords 348 are keywords related to current events and activities occurring at that time on the Internet. For example, the trending keywords 348 may be related to current sports events and news items, and can be obtained from a variety of the data sources 130. The search module 410 compares the search string 340 to trending keywords from the data sources 130 to determine the trending keywords 348 for the search query 344. The search module 410 may also generate the trending keywords 348 based on the webpage keyword(s) 342. For example, on a day that there is a soccer game between Barcelona and Manchester United, the data sources 130 may return the trending keywords 348, including but not limited to, “Soccer”, “Barcelona”, “Barca”, “Man United”, Manchester United”, “Lionel Messi”, etc. These trending keywords 348 may be used to enhance the search results 440 returned from the search system 400.

In some examples, the search module 410 select ones of the trending keywords 348 identified by the data sources 130 that are related to the search query 344 (e.g., the search string or the URL). For example, the search module 410 may compare the trending keywords 348 with the webpage keywords 342 or the search string 340 to determine respective trending keyword relevance scores 366 for the trending keywords 348. If the trending keyword relevance score 366 of a trending keyword satisfies a threshold value 368 (e.g., is greater than or less than the threshold value 368) used to indicate that the trending keyword is relevant, the search module 410 searches the search data store 420 and the card records 430 for ones of the card records 430 related to that trending keyword. Ones of the trending keywords not satisfying the threshold value 368 may be discarded for the purposes of searching the card records 430.

The search module 410 searches the search data store 420 and the card records 430 for ones of the card records 430 related to the trending keyword(s) 348. The search module 410 returns the ones of the card records 430 related to the trending keywords 348 as trending card results 450b. The search system 400 processes the search string 340 as described above and obtains keyword card results 450a for the search query 344. The search module 410 replaces one of the keyword card results 450a with one or more of the trending card results 450b and the search module 410 returns the keyword card results 450a and the trending card result(s) 450b to the add-on module 300.

### Card Records

Referring to FIGS. 4E and 4F, the search data store 420 includes ones of the card records 430 based on an application state. Each of the card records 430 includes data related to a specific state of one of the applications 210 that is either installed on the user device 200 or that can be downloaded and installed on the user device 200. Each of the card records 430 may include an application card identifier (ID) 432, application state information 434, a template identifier 436, and one or more of the access mechanisms 452, 452a, 452b, 452c used to access functionality provided by the one of the applications 210.

The application card ID 432 of one of the card records 430 may be used to identify that one of the card records 430 among the other card records 430 included in the search data store 420. The application card ID 432 of one of the card records 430 may be a string of alphabetic, numeric, and/or symbolic characters (e.g., punctuation marks) that uniquely identifies that one of the card records 430. In some examples, the application card ID 432 of one of the card records 430 describes a function and/or an application state in human readable form. For example, the application card ID 432 of one of the card records 430 includes the name of the application 210 referenced in the access mechanism(s) 452. In a specific example, the application card ID 432 of one of the card records 430 for an internet music player application includes the name of the internet music player application along with the song name that will be played when the internet music player application is set into the specific state defined by the application access mechanism. In some examples, the application card ID 432 of one of the card records 430 includes a string in the format of an URL for the one of the card records 430, which uniquely identifies the one of the card records 430. In some examples, the string includes multiple parameters used to retrieve the corresponding one of the card records 430. In addition, some parameters may be user-generated, which means that the parameters put the application in a new card record 430 that has not been previously executed. Thus, a user-selectable link may not explicitly correspond to a known end result inside the application, but simply fits a known link expression that the application accepts. For example, the UBER® application may display a user selectable link that uses a latitude and longitude as a parameter to determine location.

In another example, if one of the card records 430 describes a function of the YELP® native application, the application card ID 432 of that one of the card records 430 may include the name “Yelp” along with a description of the application state described in the application state information 434 of that one of the card records 430. For example, the application card ID 432 for one of the card records 430 that describes the restaurant named “The French Laundry” may be “Yelp—The French Laundry.” If the application card ID 432 of the one of the card records 430 includes a string in the format of a URL, the application card ID 432 may include the following string “http://www.yelp.com/biz/the-french-laundry-yountville-2?ob=1” to uniquely identify that one of the card records 430. In additional examples, the application card ID 432 of one of the card records 430 may include a URL using a namespace other than “http://,” such as “func://,” which may indicate that the URL is being used as an application state ID in an application state. For example, the application card ID 432 of the one of the card records 430 of FIG. 4F may include the following string “func://www.yelp.com/biz/the-french-laundry-yountville-2?ob=1”.

The application state information 434 of one of the card records 430 includes data that describes an application state into which the associated one of the applications 210 is set according to the access mechanism(s) 452 in the one of the card records 430. Additionally or alternatively, the application state information 434 of one of the card records 430 includes data that describes the function performed according to the access mechanism(s) 452 included in the one of the card records 430. The application state information 434 may include text, numbers, and symbols that describe the application state. The types of data included in the application state information 434 may depend on the type of information associated with the application state and the functionality specified by the application access mechanism 452a. The application state information 434 may include a variety of different types of data, such as structured, semi-structured, and/or unstructured data.

In some examples, the application state information 434 of one of the card records 430 includes data that is presented to the user 10 by the associated one of the applications 210 when the application 210 is set in the application state specified by the access mechanism(s) 452 of the one of the card records 430. For example, if one of the access mechanism(s) 452 is an application access mechanism, the application state information 434 includes data that describes a specific state of one of the native applications 210a after the user device 200 has performed the one or more operations indicated in the application access mechanism. In a specific example of one of the card records 430 associated with a shopping application, the application state information 434 of the one of the card records 430 may include data that describes products (e.g., names and prices) that are shown when the shopping application is set to the application state specified by the access mechanism(s) 452 of the one of the card records 430. As another example of one of the card records 430 associated with a music player application, the application state information 434 of the one of the card records 430 includes data that describes a song (e.g., name and artist) that is played when the music player application is set to the application state specified by the access mechanism(s) 452 of the one of the card records 430.

As stated above, the types of data included in the application state information 434 of the card records 430 may depend on the type of information associated with the application state specified by the access mechanism(s) 452 of those card records 430, respectively. For example, if one of the card records 430 is for one of the applications 210 that provides reviews of restaurants, the application state information 434 of the one of the card records 430 includes information (e.g., text and numbers) related to a restaurant, such as a category of the restaurant, reviews of the restaurant, and a menu for the restaurant. In this example, the access mechanism(s) 452 of the one of the card records 430 causes the associated one of the applications 210 (e.g., one of the native applications 210a or the web browser application 210b) to launch and retrieve information relating to the restaurant. As another example, if one of the card records 430 is for one of the applications 210 that plays music, the application state information 434 of the one of the card records 430 may include information relating to a song, such as the name of the song, the artist, lyrics, and listener reviews. In this example, the access mechanism(s) 452 causes the associated one of the applications 210 to launch and play the song described in the application state information 434.

The application card ID 432 of the one of the card records 430 may be used to identify one of the native applications 210a associated with the one of the card records 430. The application card ID 432 of one of the card records 430 may be a string of alphabetic, numeric, and/or symbolic characters (e.g., punctuation marks) that uniquely identifies the associated one of the native applications 210a. In some examples, the application card ID 432 is the one of the native applications 210a in human readable form. For example, the application card ID 432 of one of the card records 430 may include the name of the associated one of the applications 210 referenced in the access mechanism(s) 452 of the one of the card records 430. As an example, the application card ID 432 of one of the card records 430 for a restaurant finder application includes the name of the restaurant finder application.

FIG. 4F shows an example card record 430 associated with the OPENTABLE® application, developed by OpenTable, Inc. The OPENTABLE® application is a restaurant-reservation application that allows users to search for restaurants and make restaurant reservations. The OPENTABLE® application provides information about restaurants including descriptions of restaurants and user reviews of the restaurants. The example one of the card records 430 of FIG. 4F describes an application state of the OPENTABLE® application in which the OPENTABLE® application accesses information for THE FRENCH LAUNDRY® restaurant.

As shown in FIG. 4F, the application card ID 432 of the one of the card records 430 includes a URL as a unique identifier for the one of the card records 430. For example, the application card ID 432 may include the string “func://www.opentable.com/the-french-laundry-yountville-2?ob=1” as a unique identifier for the one of the card records 430, or may include “func://” as a namespace, as described above.

The example application state information 434 includes data fields 435, such as a title 435a of THE FRENCH LAUNDRY® restaurant, a description 435b of THE FRENCH LAUNDRY® restaurant, image 435c of THE FRENCH LAUNDRY® restaurant, and additional data fields 435d. The title 435a field may include the text “French cuisine” and “contemporary,” for example. The description field 435b may include text that describes THE FRENCH LAUNDRY® restaurant. The image 435c may include text of user reviews for THE FRENCH LAUNDRY® restaurant. The additional data fields 435d may include additional data for THE FRENCH LAUNDRY® restaurant that may not specifically fit within the other defined fields, such as a menu for the restaurant, prices, and operating hours for the restaurant. In some implementations, instructions for accessing an application programming interface (API) via a remote API server in order to obtain additional application state information 434 are stored in the additional data fields 435d or the access mechanisms 452 of the one of the card records 430. There are many formats for the API access stored in the additional data fields or access mechanisms, any format acceptable to access the API will suffice. For example, but not limited to, the API may be stored as a URL or FUNC:// type link in order to access the web server.

The one of the card records 430 includes one or more of the access mechanisms 452. The access mechanism(s) 452 may include a reference to the OPENTABLE® application, which is one of the applications 210. An example application access mechanism for the one of the card records 430 may include a reference to the OPENTABLE® native application along with one or more operations to be performed by the user device 200. For example, the application access mechanism may include an application resource identifier and/or one or more operations that cause the user device 200 to access the entry for THE FRENCH LAUNDRY® restaurant in the OPENTABLE® native application. An example application resource identifier may be “vnd.opentable.deeplink://opentable.com/restaurant/profile?rid=1180&refid=1.”

In some implementations, one of the card records 430 may include multiple different application access mechanisms that include a variety of information. The application access mechanisms may include edition information that indicates the application edition with which ones of the application access mechanisms are compatible. For example, the edition information may indicate which operating system the application access mechanism is compatible with. Moreover, different application access mechanisms may be associated with different editions of the associated one of the applications 210. A native application edition (hereinafter “application edition”) refers to a particular implementation or variation of one of the native applications 210a. For example, an application edition may refer to a version of one of the native applications 210a, such as a version 1.0 of the one of the native applications 210a or a version 2.0 of the one of the native applications 210a. In another example, an application edition may refer to an implementation of the one of the native applications 210a for a specific platform, such as a specific operating system.

The different application access mechanisms included in one of the card records 430 may cause the corresponding application editions to launch and perform similar functions to access a particular state. Accordingly, different application access mechanisms included in one of the card records 430 may cause the corresponding application editions to be set into similar or identical application states. For example, if different application access mechanisms reference different editions of an information retrieval application, the different application access mechanisms may cause the corresponding application editions to retrieve similar information. In another example, if the different application access mechanisms reference different editions of an internet music player application, the different application access mechanisms may cause the corresponding application editions to play the same song.

In some examples, one of the card records 430 for a native application that retrieves restaurant information includes multiple different application access mechanisms for multiple different application editions. Assuming that the one of the card records 430 is associated with a specific Mexican restaurant, the application access mechanisms for the different application editions may cause each application edition to retrieve information for the same specific Mexican restaurant. For example, a first application access mechanism may cause a first application edition (e.g., on a first operating system) to retrieve information for the specific Mexican restaurant. A second application access mechanism may cause a second application edition (e.g., on a second operating system) to retrieve information for the specific Mexican restaurant.

### Method of Operation

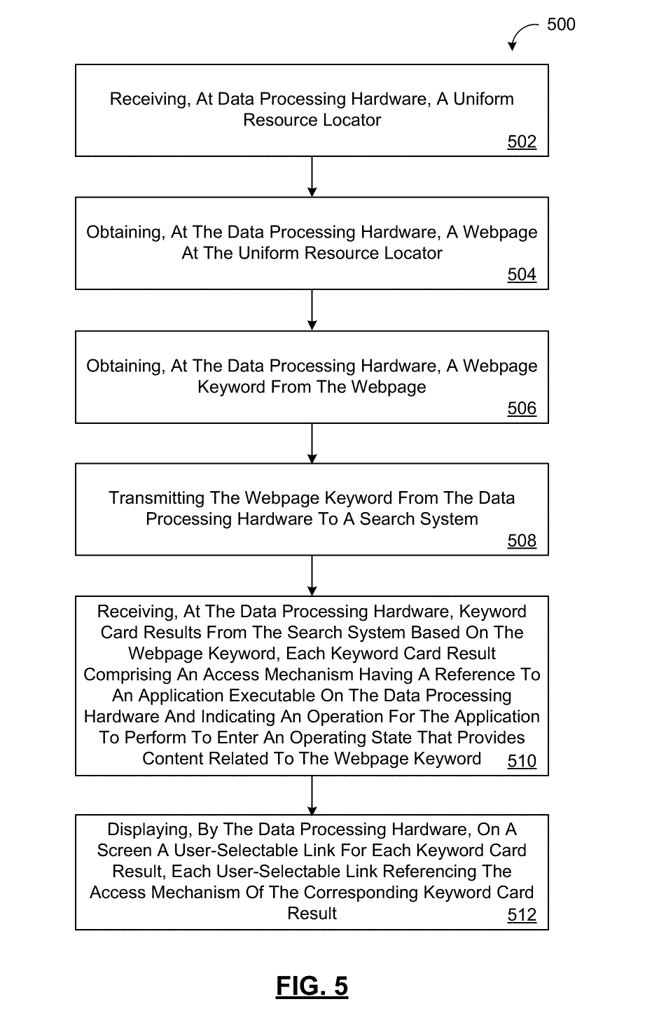

FIG. 5 provides a method 500 for operating of the add-on module 300 and the search system 400. At block 502, the method 500 includes receiving, at the data processing hardware 220, a uniform resource locator (URL) 346. The user device 200 may transmit the search query 344 including the URL 346 to the search system 400. The URL 346 directs to the webpage 350.

At block 504, the method 500 includes obtaining, at the data processing hardware 220, the webpage 350 at the URL 346. The data processing hardware 220 displays the webpage 350 on the display 216. The search system 400 and search module 410 obtain the webpage 350 via the network 120.

At block 506, the method 500 includes obtaining the webpage keyword(s) 342 from the webpage 350. The webpage keyword(s) 342 may be determined from the webpage 350 by the data processing hardware 220 (via executing the add-on module 300) or by the search system 400, for example, using RAKE.

At block 508, the method 500 may include, by the data processing hardware 220, transmitting the webpage keyword(s) 342 to the search system 400 in the example where the add-on module 300 determines the webpage keyword(s) 342. In the example where the search system 400 determines the webpage keyword(s) 342, the add-on module 300 transmits the URL 346 to the search system 400 and the search system 400 determines the webpage keyword(s) 342 via accessing the webpage 350 at the URL 346, as discussed above.

The search system 400 includes the search module 410 and search data store 420. At block 510, the method 500 includes receiving, at the data processing hardware 220, the keyword card results 450a from the search system 400 determined based on the webpage keyword(s) 342. The search module 410 accesses the search data store 420 and the card records 430. The search module 410 determines the keyword card results 450a based on ones of the card records 430 that are related to the webpage keyword(s) 342. The search module 410 converts the card records 430 related to the webpage keyword(s) 342 into the keyword card results 450a. Each of the keyword card results 450a includes an access mechanism 452 having a reference to an application executable by the data processing hardware 220 and indicating an operation for the application 210 to perform to transition to a specific state that provides content related to the webpage keyword(s) 342. At block 512, the method 500 further includes displaying, by the data processing hardware 220 on the screen 216, the user-selectable links 460 for the keyword card results 450a, respectively. Each of the user-selectable links 460 references the access mechanism(s) 452 of the corresponding one of the keyword card results 450a. The data processing hardware 220 displays the user selectable links 460 within the add-on portion 250 overlaying the webpage 350.

In some implementations, obtaining the webpage keyword(s) 342 from the webpage 350 includes executing the RAKE algorithm 354 to determine whether candidate keywords of the webpage 350 should be used as the webpage keyword(s) 342. Obtaining the webpage keyword(s) 342 from the webpage 350 may additionally or alternatively include parsing the webpage 350 for one or more candidate keywords. In some examples, the method 500 further includes assigning word scores to the candidate keywords, respectively. For each of the candidate keywords, the method 500 may include altering the respective word score based on at least one of a location of the candidate word within the webpage 350, a font type of the candidate keyword, a font size of the candidate keyword, or a usage frequency of the candidate keyword within the webpage 350, and selecting the candidate keyword having a highest one of the word scores as the webpage keyword(s) 342. The method 500 may also include ranking the candidate keyword based on a frequency of appearance of the candidate keyword in the webpage 350, and selecting the candidate keyword having the highest ranking as the webpage keyword(s) 342. The method 500 may further include comparing the candidate keyword with a title of the webpage 350, and selecting ones of the candidate keyword as the webpage keyword(s) 342 based on the comparison.

In some implementations, the method 500 includes obtaining, at the data processing hardware 220, the one or more trending keywords 348 from one or more of the data sources 130 and obtaining, at the data processing hardware 220, one or more of the trending card results 450b from the search system 400 based on the trending keyword(s) 348. The data processing hardware 220 may replace at least one of the keyword card results 450a with one or more of the trending card results 450b. The trending card results 450b may each include one or more of the access mechanisms 452 having a reference to one of the applications 210 executable on the data processing hardware 220 and indicating an operation for the one of the applications 210 to perform to transition to a specific state that provides content related to the trending keyword(s) 348. In some examples, the method 500 includes obtaining, at the data processing hardware 220, the trending keyword(s) 348 from one or more of the data sources 130 and comparing, at the data processing hardware 220, the trending keyword(s) 348 and the webpage keyword(s) 342 to determine respective trending keyword relevance scores for the trending keyword(s) 348. When the trending keyword relevance score of one of the trending keywords 348 satisfies the threshold relevance or threshold value 368, the method 500 may include obtaining, at the data processing hardware 220, the one or more trending card results 450b from the search system 400 based on the trending keyword(s) 348 and replacing, by the data processing hardware 220, at least one of the keyword card results 450a with the trending card result(s) 450b. The trending card result(s) 450b may each include one or more of the access mechanisms 452 having a reference to one of the applications 210 executable on the data processing hardware 220 and indicating an operation for the one of the applications 210 to perform to transition to a specific state that provides content related to the trending keyword(s) 348. Each of the trending card results 450b may further include an image and text having a reference to the one of the applications 210.

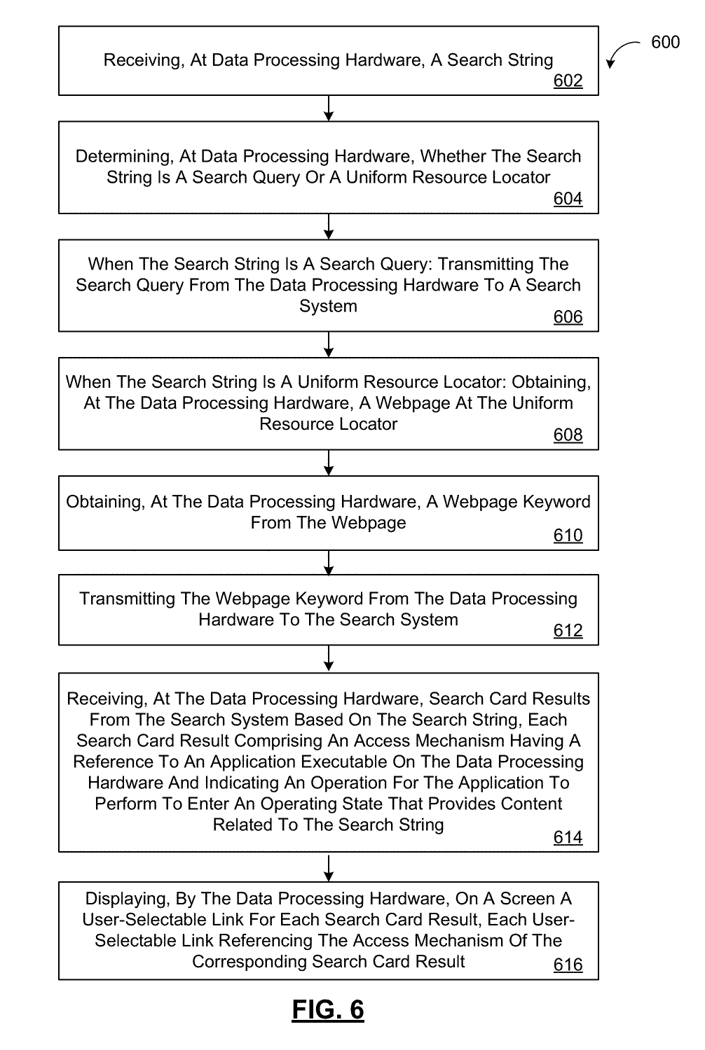

FIG. 6 provides a method 600 for operating the add-on module 300 and the search system 400. At block 602, the method 600 includes receiving, at the data processing hardware 220, the search query 344. The add-on module 300 sends the search query 344 to the search system 400 via the network 120. At block 604, the method 600 includes determining, at the data processing hardware 220, whether the search query 344 includes a search string or a URL. The search module 410 identifies a URL based on its format. A URL contains standard formatting in order to be operable and search strings, which do not contain the correct formatting, do not. At block 606, the method 600 includes when the search query 344 includes a search string, transmitting the search query 344 including the search string 340 from the data processing hardware 220 to the search system 400. The add-on module 300 transmits the search query 344 to the search system 400. At block 608, when the search query 344 includes a URL, the method 600 includes, obtaining, at the data processing hardware 220, the webpage 350 at the URL.

At block 610, the method 600 includes when the search query includes a URL, obtaining, at the data processing hardware 220, the one or more webpage keyword(s) 342 from the webpage 350 at the URL. The webpage keyword(s) 342 represent content of the webpage 350. The search module 410 or the add-on module 300 may obtain the webpage keyword(s) 342 by parsing the webpage 350.

At block 612, the method 600 includes when the search query 344 includes a URL, transmitting the webpage keyword(s) 342 from the data processing hardware 220 to the search system 400. The add-on module 300 or the search module 410 may transmit the webpage keyword(s) 342 to the search data store 420 and the card records 430. At block 614, the method 600 further includes receiving, at the data processing hardware 220, the search card results 450c from the search system 400 determined by the search system 400 based on the search string 340. Each of the search card result 450c includes one or more of the access mechanisms 452, each having a reference to one of the applications executable by the data processing hardware 220 and indicating an operation for that one of the applications 210 to perform to transition the one of the applications 210 to a specific state that provides content related to the search query 344. The search module 410 accesses the search data store 420 and the card records 430 related to the search string 340. The search module 410 generates the card results 450 based on the card records 430 related to the search string 340.

At block 616, the method 600 includes displaying, by the data processing hardware 220, on the display 216 the user-selectable links 460 for the search card results 450c. Each of the user-selectable links 460 references the access mechanism 452 of the corresponding one of the search card results 450c. Each of the search card results 450c includes one of the access mechanisms 452 having a reference to one of the applications executable on the data processing hardware 220 and indicating an operation for the one of the applications 210 to perform to transition the one of the applications 210 to a specific state that provides content related to the search query 344.

In some implementations, obtaining the webpage keyword(s) 342 from the webpage 350 includes executing the RAKE algorithm 354 to determine whether a candidate word of the webpage 350 is a webpage keyword. Obtaining the webpage keyword(s) 342 from the webpage 350 may further include parsing the webpage 350 for one or more candidate keywords. In some examples, the method 600 further includes assigning word scores to the candidate words parsed from the webpage 350. For each of the candidate words, the method 600 may include altering the respective word score based on at least one of a location of the candidate word within the webpage 350, a font type of the candidate word, a font size of the candidate word, and/or a usage frequency of the candidate word within the webpage 350, and selecting one or more of the candidate words having the highest word score(s) as the webpage keyword(s) 342. The method 600 may also include ranking the candidate words based on a frequency of appearance of the candidate words in the webpage 350, and selecting the candidate words having the highest ranking(s) as the webpage keyword(s) 342. The method 600 may further include comparing the candidate words with a title of the webpage 350, and selecting one or more of the candidate words as the webpage keyword(s) 342 based on the comparison.

In some implementations, the method 600 includes obtaining, at the data processing hardware 220, the one or more trending keywords 348 from the data sources 130 and obtaining, at the data processing hardware 220, the one or more trending card results 450b from the search system 400 based on the trending keyword(s) 348. The data processing hardware 220 may replace at least one of the keyword card results 450a with one or more of the trending card results 450b. The trending card results 450b each include one or more of the access mechanisms 452, each of the access mechanisms 452 having a reference to one of the applications 210 executable on the data processing hardware 220 and indicating an operation for the one of the applications 210 to perform to transition the one of the applications 210 to a specific state that provides content related to that one of the trending keywords 348. In some examples (e.g., when the search query 344 includes a URL), the method 600 includes obtaining, at the data processing hardware 220, the trending keyword(s) 348 from the data sources 130 and comparing, at the data processing hardware 220, the trending keyword(s) 348 and the webpage keyword(s) 342 to determine respective trending keyword relevance scores for the trending keyword(s) 348. If the search query 344 includes a search string, the search module 410 compares the trending keyword(s) 348 and the search string to determine respective trending keyword relevance scores for the trending keyword(s) 348. When the trending keyword relevance score of one of the trending keyword(s) 348 satisfies the threshold relevance or threshold value 368, the method 600 may include obtaining, at the data processing hardware 220, the trending card result 450b from the search system 400 based on the one of the trending keywords 348 and replacing, by the data processing hardware 220, at least one of the keyword card results 450a with the trending card result 450b. The trending card result 450b may include one or more of the access mechanisms 452, each of the access mechanisms 452 having a reference to one of the applications 210 executable on the data processing hardware 220 and indicating an operation for the one of the applications 210 to perform to transition the one of the applications 210 a specific state that provides content related to the one of the trending keywords 348. Each of the trending card results 450b may further include an image and text having a reference to the one of the applications 210.

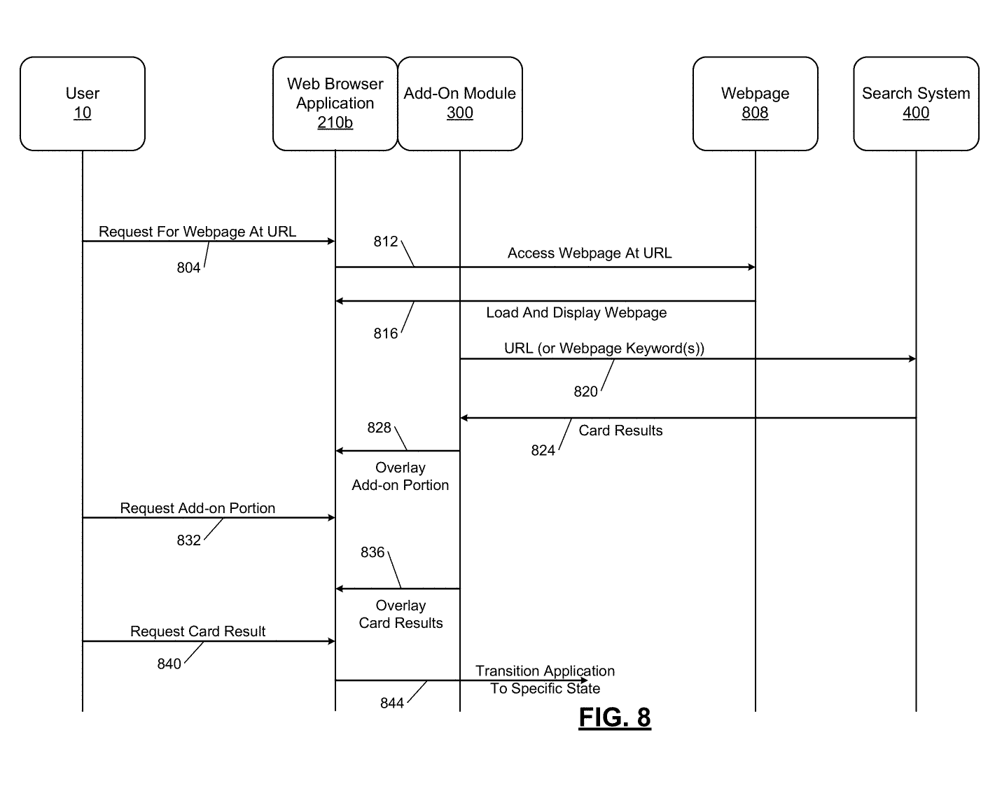

FIG. 8 includes an example flowchart illustrating an example method of operation of the add-on module 300 with the web browser application 210b. At 804, via the user device 200 receives a request from the user 10 for the web browser application 210b to load a webpage 808 that is located at a URL. At 812, the data processing hardware 220 (executing the web browser application 210b) accesses the webpage 808 located at the URL. The data processing hardware 220 (executing the web browser application 210b) loads and displays the webpage 808 located at the URL on the display 216 at 816.

At 820, the data processing hardware 220 executing the add-on module 300 transmits the URL to the search system 400 requesting that the search system 400 provide card results based on the URL. The search system 400 determines webpage keywords for the webpage 808, for example, using the RAKE algorithm 354. The search system 400 may execute the RAKE algorithm 354, for example, on the DOM of the webpage 808 at the URL. In various implementations, instead of transmitting the URL to the search system 400, the data processing hardware 220 executing the add-on module 300 may determine the webpage keywords for the webpage 808 (using the RAKE algorithm 354) and transmit the webpage keywords for the webpage 808 to the search system 400.

The search system 400 (e.g., the data processing hardware 112) searches the card records 430 for ones of the card records 430 that are related to the webpage keywords for the webpage 808. The search system 400 returns ones of the card records 430 that are related to the webpage keywords at 824.

At 828, the data processing hardware 220 executing the add-on module 300 overlays the add-on portion 250 on the webpage 808 displayed on the display 216. At 832, once the add-on portion 250 is overlayed, the user device 200 may receive a request from the user 10 to display the card results 824, such as the user interacting with (e.g., touching or clicking) the add-on portion 250 on the display 216.

In response, at 836 the data processing hardware 220 executing the add-on module 300 overlays the card results over the webpage 808 on the display 216. Different ones of the card results may be brought onto the display 216, for example, by the user swiping left, right, up, or down on the display 216.

If the user device 200 receives a request from the user 10 for one of the card results displayed at 840, the data processing hardware 220, executing the one of the access mechanisms 452 included in that one of the card results 450, transitions the associated one of the applications 210 to the specific state at 844. This may include launching the associated one of the applications 210 on the user device 200. If the associated one of the applications 210 is not currently installed on the user device 200, the data processing hardware 220 may access one of the digital distribution platforms 130b to download the associated one of the applications 210. This is performed for each webpage that the user requests the web browser application 210b to navigate to.

Generally speaking, in the example of the web browser application 210b being the Mozilla Firefox web browser application, after installation the add-on module 300 is part of the web browser application 210b, thereby allowing it to execute in the background. For any webpage that a user visits, the add-on module 300 injects code into the webpage when the webpage is loaded (e.g., to overlay the add-on portion 250 over the webpage). In the Mozilla Firefox example, the add-on module 300 may inject JavaScript into the loaded webpage. Once this is done, the injected code now has full access to the content of the webpage (in other words, the document object model or DOM) and it can determine the user's context in order to request relevant cards for the webpage. The add-on module renders the results cards as part of the webpage.

For example, a user may open the Wikipedia page for the Jurassic World Movie, “https://en.wikipedia.org/wiki/Jurassic_World”. A user may visit this page while they browse the Internet. Upon the web browser application 210b loading the page, the add-on module 300 sends the URL of the webpage to the search system 400 which can use the URL to access and retrieve content from the webpage, such as a title, metadata, keywords, etc. The search system 400 can use the content to generate a search query related to the content of the webpage at the URL. For example, the search system 400 can determine a search query based on one or more highest scoring webpage keywords within the webpage. The search system 400 may determine search queries using RAKE (discussed in detail below) or another suitable method of extracting keywords/key phrases from a body of text of a webpage. In some examples, the add-on module 300 executing on the web browser application 210b may implement some of the functionality required to extract keywords/search queries. In this way, the add-on module 300 may not transmit the URL of the webpage, and the search system 400 may not need to access the URL to acquire content from the corresponding web page. Instead, the add-on module 300 may generate the search query in the way that the search system 400 would, and the search system 400 may identify or generate card results based on the search query received from the add-on module 300.

Returning to the example involving the Wikipedia page “https://en.wikipedia.org/wiki/Jurassic_World”, the search query determined may be “Jurassic World Movie.”

When the user is browsing instead of explicitly performing a search via a search engine for a search string, the add-on module 300 may not immediately display the card results. Instead, the add-on module 300 may display a hover icon or a collapsed browser tray on the display 216, such as the add-on portion 250. When the user interacts with the add-on portion 250, the add-on module 300 may increase the dimensions of the add-on portion 250 and display the card results on the display 216. As discussed further below, when the user is performing a search for a search string, the add-on module 300 may display the results cards immediately instead of requiring that the user interact with the add-on portion 250 of the display before displaying the results cards.

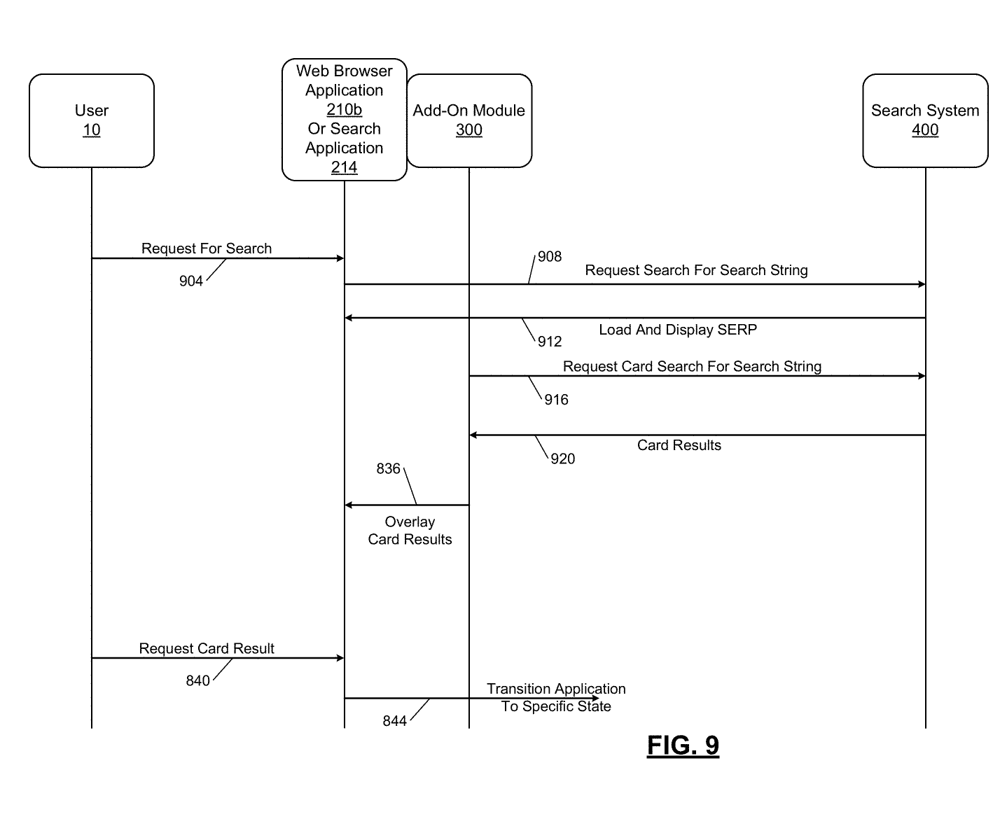

FIG. 9 includes an example flowchart illustrating an example method of operation of the add-on module 300 with the web browser application 210b or the search application 214. The web browser application 210b and the search application 214 may use a predetermined search engine by default or one of a plurality of search engines to use may be user selected.

At 904, the user device 200 receives a request from the user 10 for to search for a search string. At 908, the data processing hardware 220 transmits a search query including the search string to the search engine requesting that the search engine provide for the search query. The data processing hardware 220 loads and displays a resulting SERP for the search query on the display 216 at 912. During execution of the web browser application 210b, the data processing hardware 220 may distinguish the search string from a URL based on the search string not complying with one or more formatting requirements of URLs.

At 916, the data processing hardware 220 executing the add-on module 300 transmits a request for card results based on the search string. The search system 400 (e.g., the data processing hardware 112) searches the card records 430 for ones of the card records 430 that are related to the search string. The search system 400 returns ones of the card records 430 that are related to the search string at 920 as the card results 450. Control may then continue with 836-840, as described above, and display the card results 450 overlaying (or within) the SERP for the search string. In this manner, the card results 450 may be displayed immediately instead of requiring that the user interact with the add-on portion before displaying the card results 450. Alternatively, the data processing hardware 220 executing the add-on module 300 may first overlay the add-on portion 250 over (or within) the SERP and display the card results 450 when the user interacts with (e.g., touching or clicking) the add-on portion 250 on the display 216.

Generally speaking, the add-on module 300 may be configured to conduct searches and display SERPs of a number of different search engines, such as Google.com, Yahoo.com, Bing.com, and Yandex.com. As an example, a user may enter a search string such as “angry birds” and chooses one of the search engines, such as Yahoo, to trigger a search based on the search string. Triggering a search does not require receipt of any special user input. A search may be triggered, for example, as the user inputs a search string or when the user selects or clicks a search button or icon. The choice of search engine may be accomplished by entering the search query into a search field of one of the search engines during execution of the web browser application 210b. This may be an alternative to the user selecting a search engine from a list.

In response to entering a search string and triggering a search, the add-on module 300 retrieves the search query. In one example, the add-on module 300 may extract the search query from the URL of the SERP, for example, using the URL schema of the search engine. For example, a search query by the Google search engine may result in a URL that contains the substring “q=angry birds”. In this example, the add-on module 300 may recognize the substring of the URL that represents a search query (for the search string “angry birds”) entered by the user into the search engine. The add-on module 300 may store (e.g., hardcoded into the installed add-on and/or downloaded/updated periodically) a configuration file that allows the add-on module 300 to identify a search engine and its corresponding URL schema. In this way, the add-on module 300 may identify search strings based on the URL of a search query.

Upon triggering a search, the web browser application 210b or the search application 214 renders a SERP as it would normally for the search. The add-on module 300 renders and displays the card results 450 for the search overlaying the SERP (e.g., via a graphical overlay) or it may render and display the cards within the SERP itself. The user can swipe horizontally, and scroll up and down to see the card results 450 provided by the add-on module 300.

As mentioned above, the card results 450 provided during a search may be monetized. In other words, a developer of the add-on module 300 may be paid by advertisers of the applications and websites associated with card results 450 to provide the sponsored/advertised card results in particular situations (e.g., in response to particular search queries or contextual information).

### Computing Devices

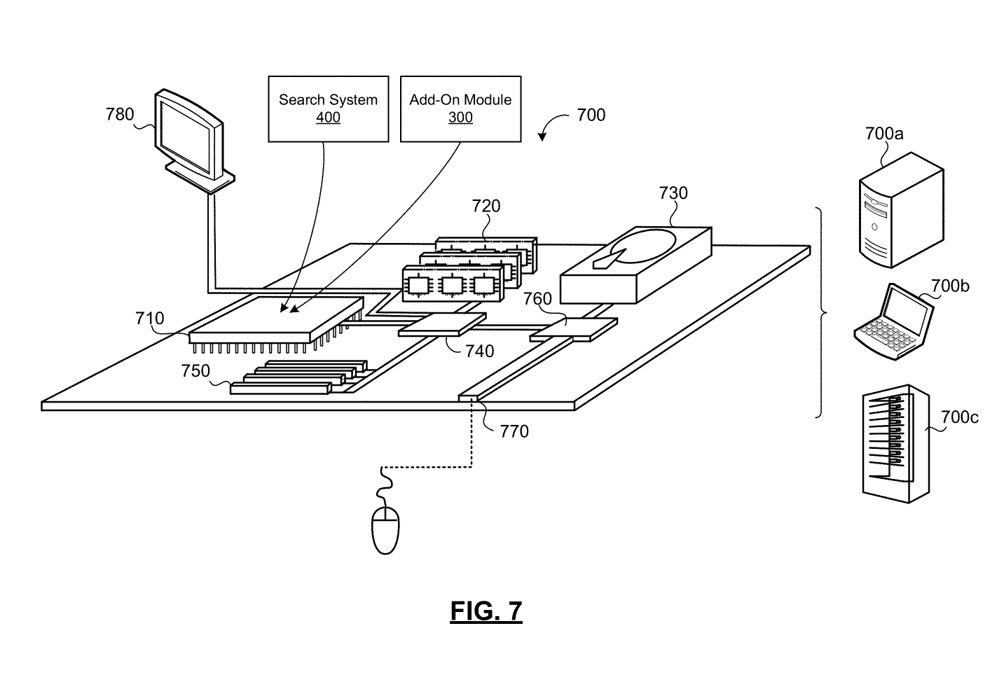

FIG. 7 is schematic view of an example computing device 700 that may be used to implement the systems and methods described in this document. The computing device 700 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the disclosures described and/or claimed in this document.

The computing device 700 includes one or more processors, such as processor 710, memory 720, a storage device 730, a high-speed interface/controller 740 connecting to the memory 720 and high-speed expansion ports 750, and a low speed interface/controller 760 connecting to low speed bus 770 and storage device 730. Each of the components 710, 720, 730, 740, 750, and 760, are interconnected using various busses, and may be mounted on a common motherboard or in other manners as appropriate. The processor 710 can process instructions for execution within the computing device 700, including instructions stored in the memory 720 or on the storage device 730 to display graphical information for a graphical user interface (GUI) on an external input/output device, such as display 780 coupled to high speed interface 740. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 720 stores information non-transitorily within the computing device 700. The memory 720 may be a computer-readable medium, a volatile memory unit(s), or non-volatile memory unit(s). The non-transitory memory 720 may be physical devices used to store programs (e.g., sequences of instructions) or data (e.g., program state information) on a temporary or permanent basis for use by the computing device 700. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM).

The storage device 730 is capable of providing mass storage for the computing device 700. In some implementations, the storage device 730 is a computer-readable medium. In various different implementations, the storage device 730 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 720, the storage device 730, or memory on processor 710.

The high speed controller 740 manages bandwidth-intensive operations for the computing device 700, while the low speed controller 760 manages lower bandwidth-intensive operations. Such allocation of duties is exemplary. In some implementations, the high-speed controller 740 is coupled to the memory 720, the display 780 (e.g., through a graphics processor or accelerator), and to the high-speed expansion ports 750, which may accept various expansion cards (not shown). In some implementations, the low-speed controller 760 is coupled to the storage device 730 and low-speed expansion port 770. The low-speed expansion port 770, which may include various communication ports (e.g., USB, Bluetooth, Ethernet, wireless Ethernet), may be coupled to one or more input/output devices, such as a keyboard, a pointing device, a scanner, or a networking device, such as a switch or router, e.g., through a network adapter.

The computing device 700 may be implemented in a number of different forms, as shown in the figure. For example, it may be implemented as a standard server 700a or multiple times in a group of such servers 700a, as a laptop computer 700b, or as part of a rack server system 700c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

### CONCLUSION

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

None of the elements recited in the claims are intended to be a means-plus-function element within the meaning of 35 U.S.C. §112(f) unless an element is expressly recited using the phrase “means for” or, in the case of a method claim, using the phrases “operation for” or “step for.”

What is claimed is:

1. A method, comprising:
receiving, by one or more processors of a user device, a uniform resource locator (URL);
obtaining, by the one or more processors, a webpage at the URL;
displaying, by the one or more processors, the obtained webpage on a display of the user device;
determining, by the one or more processors, a webpage keyword from the obtained webpage;
transmitting, by the one or more processors, the webpage keyword to a search system;
receiving, by the one or more processors, keyword card results from the search system selected based on the webpage keyword,
wherein each keyword card result of the keyword card results includes, for a respective user-selectable link, a respective access mechanism:
that is associated with an application that is executable by the one or more processors; and
that, when executed by the one or more processors, causes the one or more processors to transition the application to a specific state that provides content related to the webpage keyword;
concurrently with the displaying of the obtained webpage, displaying on the display of the user device, by the one or more processors, the user-selectable links for the keyword card results, respectively; and
in response to user selection of one of the user-selectable links, executing, by the one or more processors, the respective access mechanism of the respective keyword card result.

2. The method of claim 1, wherein determining the webpage keyword comprises, by the one or more processors, determining the webpage keyword from a title of a document object model (DOM) of the obtained webpage.

3. The method of claim 1, wherein determining the webpage keyword comprises:
by the one or more processors, executing a Rapid Automatic Keyword Extraction (RAKE) algorithm on text of the obtained webpage to determine candidate keywords; and
selecting one of the candidate keywords as the webpage keyword.

4. The method of claim 1 wherein determining the webpage keyword comprises:
determining candidate keywords from the obtained webpage;
determining word scores for the candidate keywords, respectively;
for each candidate keyword of the candidate keywords, selectively adjusting the word score of the candidate keyword based on at least one of:
one or more locations of the candidate keyword within the obtained webpage;
one or more typefaces of the candidate keyword within the obtained webpage;
one or more font sizes of the candidate keyword within the obtained webpage; and
a usage frequency of the candidate keyword within the obtained webpage; and
selecting as the webpage keyword, by the one or more processors, the one of the candidate keywords with a highest one of the word scores.

5. The method of claim 1 wherein determining the webpage keyword comprises:
determining candidate keywords from the obtained webpage;
ranking the candidate keywords based on frequencies of appearance of the candidate keywords, respectively, in the obtained webpage; and
selecting as the webpage keyword, by the one or more processors, the one of the candidate keywords with a highest ranking.

6. The method of claim 1, further comprising:
receiving, by the one or more processors, a trending card result from the search system selected based on a trending keyword,
wherein the trending card result includes, for a second user-selectable link, a second access mechanism:
that is associated with an application that is executable by the one or more processors of the user device; and
that, when executed by the one or more processors, causes the one or more processors to transition the application to a specific state that provides content related to the trending keyword;
displaying on the display of the user device, by the one or more processors, the second user-selectable link for the trending card result; and
in response to user selection of the second user-selectable link executing, by the one or more processors, the second access mechanism of the trending card result.

7. The method of claim 6, further comprising, by the one or more processors, replacing on the display, one of the user-selectable links for the keyword card results with the second user-selectable link for the trending card result.

8. The method of claim 1, wherein:
each keyword card result of the keyword card results further comprises data associated with an image and data associated with text; and
the method further comprises displaying on the display, by the one or more processors, the images and the text of the keyword card results with the user-selectable links, respectively.

9. The method of claim 1 wherein the displaying the user-selectable links includes displaying the user-selectable links only in response to receipt of predetermined user input, by the one or more processors, to display the user-selectable links.

10. A method, comprising:
receiving, by one or more processors of a user device, a uniform resource locator (URL);
obtaining, by the one or more processors, a webpage at the URL;
displaying, by the one or more processors, the obtained webpage on a display of the user device;
transmitting, by the one or more processors, the URL for the obtained webpage to a search system;
receiving, by the one or more processors, keyword card results from the search system selected by the search system based on a webpage keyword for the obtained webpage,
wherein each keyword card result of the keyword card results includes, for a respective user-selectable link, a respective access mechanism:
that is associated with an application that is executable by the one or more processors; and
that, when executed by the one or more processors, causes the one or more processors to transition the application to a specific state that provides content related to the URL;
concurrently with displaying the obtained webpage, displaying on the display of the user device, by the one or more processors, the user-selectable links for the keyword card results, respectively; and
in response to user selection of the user-selectable links, executing, by the one or more processors, the respective access mechanisms of the respective keyword card results.

11. The method of claim 10, further comprising:
receiving, by the one or more processors, a trending card result from the search system selected based on a trending keyword,
wherein the trending card result includes, for a second user-selectable link, a second access mechanism:
that is associated with an application that is executable by the one or more processors; and
that, when executed by the one or more processors, causes the one or more processors to transition the application to a specific state that provides content related to the trending keyword;
displaying on the display of the user device, by the one or more processors, the second user-selectable link for the trending card result; and
in response to user selection of the second user-selectable link executing, by the one or more processors, the second access mechanism of the trending card result.

12. The method of claim 11, further comprising, by the one or more processors, replacing on the display, one of the user-selectable links for the keyword card results with the second user-selectable link for the trending card result.

13. The method of claim 10, wherein:
each keyword card result of the keyword card results further comprises data associated with an image and data associated with text, and
the method further comprises displaying on the display, by the one or more processors, the images and the text of the keyword card results with the user-selectable links, respectively.

14. The method of claim 10 wherein the displaying on the display, the user-selectable links for the keyword card results, respectively, includes displaying the user-selectable links only in response to receipt of predetermined user input, by the one or more processors, to display the user-selectable links.

15. A method, comprising:
receiving, by one or more processors of a user device, a search string to be searched for by a search engine;
obtaining from a search engine, by the one or more processors, a search engine results page (SERP) for the search string;
displaying, by the one or more processors, the SERP on a display of the user device;
transmitting, by the one or more processors, the search string to a search system that is separate from the search engine;
receiving, by the one or more processors, keyword card results from the search system selected based on the search string,
wherein each keyword card result of the keyword card results includes, for a respective user-selectable link, a respective access mechanism:
that is associated with an application that is executable by the one or more processors; and
that, when executed by the one or more processors, cause the one or more processors to transition the application to a specific state that provides content related to the search string;
concurrently with displaying the SERP, displaying on the display of the user device, by the one or more processors, the user-selectable links for the keyword card results, respectively; and
in response to user selection of the user-selectable links, executing, by the one or more processors, the respective access mechanisms of the respective keyword card results.

16. The method of claim 15 further comprising, by the one or more processors, obtaining the search string from a portion of a URL of the SERP.

17. The method of claim 15 further comprising, by the one or more processors, obtaining the search string from a search field of a webpage of the search engine.

18. The method of claim 15 further comprising, by the one or more processors, obtaining the search string from a search field of an application being executed by the one or more processors.

19. The method of claim 15, further comprising:
receiving, by the one or more processors, a trending card result from the search system selected based on a trending keyword,
wherein the trending card result includes, for a second user-selectable link, a second access mechanism:
that is associated with an application that is executable by the one or more processors of the user device; and
that, when executed by the one or more processors, causes the one or more processors to transition the application to a specific state that provides content related to the trending keyword;
displaying on the display of the user device, by the one or more processors, the second user-selectable link for the trending card result; and
in response to user selection of the second user-selectable link executing, by the one or more processors, the second access mechanism of the trending card result.

20. The method of claim 19, further comprising, by the one or more processors, replacing on the display one of the user-selectable links for the keyword card results with the second user-selectable link for the trending card result.

21. The method of claim 15, wherein:
each keyword card result of the keyword card results further comprises data associated with an image and data associated with text; and
the method further comprises displaying on the display, by the one or more processors, the images and the text of the keyword card results with the user-selectable links, respectively.

22. The method of claim 15 wherein the displaying on the display, the user-selectable links for the keyword card results, respectively, includes displaying the user-selectable links only in response to receipt of predetermined user input, by the one or more processors, to display the user-selectable links.
